(19) United States
(12) Patent Application Publication
(10) Pub. No.: US 2026/0134613 A1
(43) Pub. Date: May 14, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: SHUN SUGIMOTO, Tokyo (JP); EIJI IMAO, Kanagawa (JP); MASANORI FUKADA, Tokyo (JP)

(21) Appl. No.: 19/378,898

(22) Filed: Nov. 4, 2025

(30) Foreign Application Priority Data
Nov. 12, 2024 (JP) 2024-197523

(51) Int. Cl. G06T 15/20; G06V 20/70

(52) U.S. Cl. CPC G06T 15/20; G06V 20/70

(57) ABSTRACT

There is provided with an information processing apparatus. An obtaining unit obtains encoded data of a three-dimensional image and metadata corresponding to the encoded data of the three-dimensional image. The metadata includes region information relating to one partial region in the three-dimensional image; first annotation information and second annotation information that are associated with the one partial region; first condition information; and second condition information. A generating unit generates a three-dimensional image file storing the encoded data of the three-dimensional image and the metadata.

### BACKGROUND

### Field of the Technology

The present disclosure relates to an information processing apparatus, an information processing method, and a storage medium.

### Description of the Related Art

In recent years, technology for generating three-dimensional data such as free-viewpoint video and point group data from data measured using images from a plurality of image capturing apparatuses, a Light Detection and Ranging (LiDAR) sensor, or the like have become known. Volumetric media data and similar three-dimensional data are normally compressed and encoded to reduce the data size. The Moving Pictures Experts Group (MPEG) is standardizing the format for volumetric media such as three-dimensional images and three-dimensional video. Examples of a method for encoding three-dimensional data include, for example, Geometry-based Point Cloud Compression (G-PCC) for compressing point cloud data, Visual Volumetric Video-based Coding (V3C) for compressing volumetric media, and the like. Three-dimensional data compressed and encoded using G-PCC, V3C, or the like can be stored in a file of a derived format such as Base Media File Format of ISO/IEC 14496-12 (ISOBMFF).

Also, in recent years, generation of annotation relating to an object in image content is performed by analyzing the image content. Annotation is annotation information indicating the result of object recognition as a character string that is readable by a human or a computer or as a parameter for identifying and classifying the object. The generation of annotation may be determined by a human looking at an image, but in most cases, this is performed by AI image recognition processing. At this time, the object recognized by the AI processing is indicated as a partial region in the image, and processing to provide or associate annotation with the partial region is executed. In such image recognition processing, a three-dimensional object can be identified in three-dimensional volumetric data as well, and information indicating a three-dimensional partial region showing the identified object and information indicating the annotation provided to the partial region can be generated.

In the technology described in Japanese Patent Laid-Open No. 2006-211531, annotation information is provided for any three-dimensional region in three-dimensional data. Also, in the technology described in Japanese Patent Laid-Open No. 2013-232730, annotation information (additional information) is provided for any three-dimensional region.

For example, in a case where a three-dimensional object surrounded by a three-dimensional region provided with a plurality of annotations is displayed on a 2D display apparatus, whether an annotation needs to be displayed, whether to selectively display the annotation, and the like need to be determined depending on the distance between the viewpoint position and the object position in the three-dimensional space and how the three-dimensional object is displayed in the current viewport (display region). However, in Japanese Patent Laid-Open No. 2006-211531, there is no mention of a method of selectively switching the annotation to display in a case where a plurality of annotations are provided for any three-dimensional region. In other words, with Japanese Patent Laid-Open No. 2006-211531, it is not possible to store selectable annotations.

Also, in Japanese Patent Laid-Open No. 2013-232730, there is no mention of a method of selectively switching and providing annotation information as selectable information in the case where annotation information indicating the inside of a three-dimensional region is provided for any three-dimensional region in a three-dimensional space. For example, for a three-dimensional object represented in a three-dimensional region, annotation information for a case of displaying from a wider space and annotation information for a case of displaying the three-dimensional region from the inside of the three-dimensional region cannot be separately defined as information that can be switched and be selected. In other words, in the case of viewing from a wider space, even if annotation information indicates the inside, it is associated with the three-dimensional media data as annotation information in a similar manner.

### SUMMARY

According to an embodiment of the present disclosure, provided is an information processing apparatus that provides a three-dimensional image file that allows selection of annotation information to be displayed according to the viewpoint.

According to one embodiment of the present disclosure, an information processing apparatus comprises: an obtaining unit configured to obtain encoded data of a three-dimensional image and metadata corresponding to the encoded data of the three-dimensional image, the metadata including: region information relating to one partial region in the three-dimensional image; first annotation information and second annotation information that are associated with the one partial region; first condition information indicating a first condition that is related to display of the first annotation information and that corresponds to a first viewpoint position or a first view direction in a three-dimensional space of the three-dimensional image; and second condition information indicating a second condition that is related to display of the second annotation information and that corresponds to a second viewpoint position or a second view direction in the three-dimensional space of the three-dimensional image; and a generating unit configured to generate a three-dimensional image file storing the encoded data of the three-dimensional image and the metadata.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of the hardware configuration of an information processing apparatus according to a first embodiment.

FIG. 2 is a diagram for describing a three-dimensional file according to the first embodiment.

FIG. 3 is a diagram for describing a three-dimensional region according to the first embodiment.

FIG. 4 is a flowchart illustrating an example of file generation processing according to the first embodiment.

FIG. 5 is a flowchart illustrating in detail an example of viewpoint condition setting processing.

FIGS. 6A-6B are diagrams illustrating an example of the structure of a file according to the first embodiment.

FIG. 7 is a diagram illustrating an example of an item format of annotation information according to the first embodiment.

FIG. 8 is a diagram illustrating an example of the format of a three-dimensional region set according to the first embodiment.

FIG. 9 is a diagram illustrating an example of the format of viewpoint condition information according to the first embodiment.

FIG. 10 is a diagram illustrating an example of the format of dimension coordinates range according to the first embodiment.

FIG. 11 is a diagram for describing display of annotation information according to a second embodiment.

FIG. 12 is a diagram for describing a viewport according to the second embodiment.

FIG. 13 is a diagram for describing a viewport according to the second embodiment.

FIG. 14 is a flowchart illustrating an example of file generation processing according to the second embodiment.

FIGS. 15A-15B are diagrams illustrating an example of the structure of a file according to the second embodiment.

FIG. 16 is a diagram illustrating an example of the description format of item ID or item type.

FIG. 17 is a diagram illustrating an example of the description format of an item storage place.

FIG. 18 is a diagram illustrating an example of the description format of attribute information.

FIG. 19 is a diagram illustrating an example of the description of a three-dimensional region according to the second embodiment.

FIG. 20 is a diagram illustrating an example of the description format of the position and size of a cuboid partial region.

FIG. 21 is a diagram illustrating an example of a format for describing the coordinates in a coordinate system of a reference point.

FIG. 22 is a diagram illustrating an example of a format for describing the rotation of a cuboid using quaternion.

FIG. 23 is a diagram illustrating an example of the description format of a virtual viewport.

FIG. 24 is a diagram illustrating an example of the description format of camera information of a virtual viewport.

FIG. 25 is a diagram illustrating an example of the range description format of the viewpoint position of a virtual viewport.

FIG. 26 is a diagram illustrating an example of the size description format of a virtual viewport.

FIG. 27 is a diagram for describing the range of a viewpoint position of a virtual viewport.

FIG. 28 is a flowchart illustrating an example of file reproduction processing according to a third embodiment.

FIG. 29 is a diagram for describing an example of display according to a viewpoint position according to the third embodiment.

FIG. 30 is a diagram for describing another example of display according to a viewpoint position according to the third embodiment.

FIG. 31 is a diagram for describing another example of display according to a viewpoint position according to the third embodiment.

FIG. 32 is a diagram for describing another example of display according to a viewpoint position according to the third embodiment.

FIG. 33 is a diagram illustrating an example of the description format of the position and size of a cuboid partial region.

FIGS. 34A-34B are diagrams illustrating an example of the structure of a file according to a fourth embodiment.

FIG. 35 is a diagram illustrating an example of three-dimensional image data according to the fourth embodiment.

FIG. 36 is a schematic view illustrating an example of a file metadata structure according to the fourth embodiment.

FIG. 37 is a flowchart illustrating an example of file generation processing according to the fourth embodiment.

FIGS. 38A-38B are flowcharts illustrating an example of file reproduction processing according to a fifth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

An information processing apparatus according to the first embodiment obtains encoded data of a three-dimensional image and metadata corresponding to the encoded data of the three-dimensional image and generates a three-dimensional image file storing this data. The metadata includes region information relating to a partial region in the three-dimensional image; annotation information associated with the partial region; first condition information indicating a first condition that is related to display of the first annotation information and that corresponds to a first viewpoint position or a first view direction in a three-dimensional space of the three-dimensional image; and second condition information indicating a second condition that is related to display of the second annotation information and that corresponds to a second viewpoint position or a second view direction in the three-dimensional space of the three-dimensional image. Here, the data of the three-dimensional image is not particularly limited to this format, and in the example described below, the data includes information of the object shape in three-dimensional space and texture information.

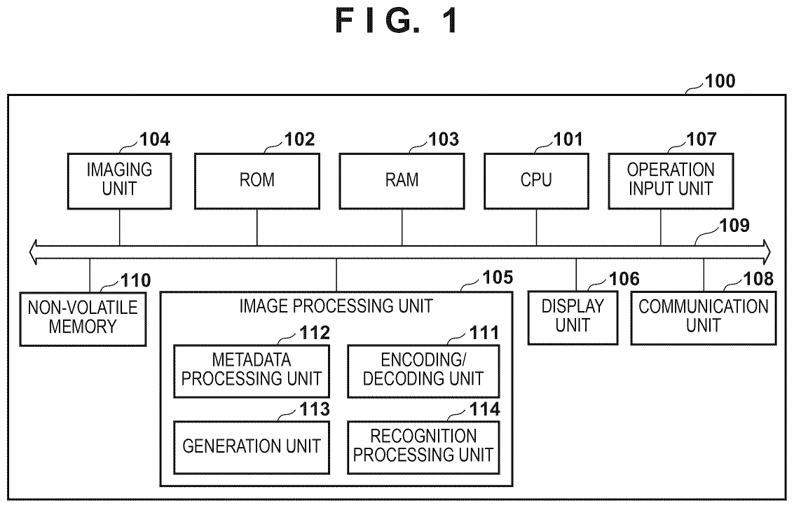

FIG. 1 is a block diagram illustrating an example of the hardware configuration of an information processing apparatus 100 according to the present embodiment. Each functional unit included in the information processing apparatus 100 is connected so that information can be exchanged via a system bus 109. Note that each functional unit of the information processing apparatus 100 is implemented as hardware including a processor, but the configuration is not particularly limited thereto, and it is sufficient that similar processing can be executed. For example, one or more or all of the functions described hereinafter may be implemented via software by implementing a program for realizing functions similar to each functional unit. In this case, it is not necessary to isolate the illustrated functional configurations per unit on whether the processing by each functional unit is implemented via hardware or software.

A CPU 101 controls the operations of each functional unit of the information processing apparatus 100. A ROM 102 is a non-volatile storage apparatus. A RAM 103 is a volatile storage apparatus capable of temporary data storage. The CPU 101 reads out a system program, a control program for each functional unit, an application program, or the like stored in the ROM 102 and loads it onto the RAM 103 to be executed. Also, the ROM 102 also stores information of parameters, data for display, and the like that are required in the processing of each function. The RAM 103 is used as an input/output buffer for temporarily storing data for input or output in the processing of each functional unit. For example, the RAM 103 is also used as a data buffer in the image file storage processing described below and an output destination for temporarily storing image data or metadata for storing in the image file.

An imaging unit 104 is an image sensor such as a CMOS sensor or a CCD, for example. The imaging unit 104 performs photoelectric conversion of an optical image formed on an imaging surface of the image sensor via a not-illustrated optical system. Also, the imaging unit 104 includes a circuit for executing noise removal and gain processing on the output signal of the image sensor, further includes an A/D converter circuit or the like for converting an analog signal to a digital signal, and outputs a digital image signal (image data).

An image processing unit 105 executes various types of image processing on the image data. The image processing according to the present embodiment includes, for example, gamma conversion, color space conversion, white balancing, exposure correction and similar processing relating to development. Also, the image processing unit 105 may be capable of executing image data analysis processing and combining processing for combining two or more pieces of image data. The image processing unit 105 includes an encoding/decoding unit 111, a metadata processing unit 112, a generation unit 113, and a recognition processing unit 114. In the present embodiment, to facilitate understanding of the embodiment, one piece of hardware, the image processing unit 105, is used to execute each item of image processing. However, some or all of the image processing may be executed by different pieces of hardware.

The encoding/decoding unit 111 is a codec for moving images and still images compliant with H.265 (HEVC), H.264 (AVC), H.266 (VVC), AV1, JPEG, G-PCC, V3C, or the like. The encoding/decoding unit 111 executes encoding and decoding processing of three-dimensional point group images, captured still images, or moving image data handled by the information processing apparatus 100.

The metadata processing unit 112 obtains data (encoded data) encoded by the encoding/decoding unit 111. Next, the metadata processing unit 112 generates an image file of a file format compliant with ISOBMFF. Specifically, the metadata processing unit 112 executes analysis processing of the encoded data stored in image files such as three-dimensional point group images, still images and video sequences and obtains parameter information relating to encoded data. Then, the metadata processing unit 112 executes processing to generate metadata to be stored in the file together with the encoded data. Note that the metadata processing unit 112 can generate metadata not only for a file compliant with ISOBMFF but also for other moving image file formats and JPEG files. Note that the encoded data obtained here may be data stored in the ROM 102 or a non-volatile memory 110 in advance or obtained via a communication unit 108 and stored in the buffer of the RAM 103.

Also, the metadata processing unit 112 processes the metadata stored in the file. In particular, the metadata processing unit 112 executes processing to obtain and analyze metadata such as parameters required to decode the image data and parameters required for display and reproduction.

The generation unit 113 generates region information indicating a partial region where an object detected by the recognition processing unit 114 can be identified. Here, since a three-dimensional image is used as the image to be processed, a three-dimensional partial region in three-dimensional space is used as the partial region. In generating information data of the partial region or the like, input via an operation input unit 107 by the user operating the information processing apparatus 100 may also be used and not only the detection result from the recognition processing unit 114. For example, in the case of setting the region of the partial region, a region recognized by the recognition processing unit 114 may be used and a region designated by user input may be used. Hereinafter, when simply “partial region” is used, it indicates a three-dimensional partial region in a three-dimensional image.

The metadata processing unit 112 obtains (generates) metadata that includes region information relating to a partial region in the three-dimensional image; annotation information associated with the partial region; and condition information, associated with the region information or the annotation information, indicating a condition relating to display of the annotation information in accordance with the viewpoint position or view direction in the three-dimensional image. Though details are described below, the metadata processing unit 112 generates, as region information, information indicating the coordinates for identifying the three-dimensional partial region and the shape of the three-dimensional partial region from the information of the three-dimensional partial region generated by the generation unit 113. Also, the metadata processing unit 112 executes analysis processing for the metadata at the time of three-dimensional image data reproduction processing.

The recognition processing unit 114 executes object detection and recognition processing (using a machine learning model or the like, for example) with the image data obtained as a storage target as the processing target. Note that the object recognition processing described as being executed by the recognition processing unit 114 may be executed by a different apparatus such as an image recognition server or the like, and the recognition processing unit 114 may obtain the result of the processing. The recognition processing unit 114 obtains various types of information such as the position, range, and the like of the detected object in the image. Here, since a three-dimensional image is used as the image to be processed, information of a partial region in a three-dimensional coordinate space is obtained as the partial region indicating the object. Note that the image recognition processing according to the present embodiment may include detection and recognition processing for a plurality of objects and processing to classify the objects.

A display unit 106 is, for example, a liquid crystal display (LCD) or the like integrally formed with the information processing apparatus 100 or is a display apparatus that can be attached to and detached from the information processing apparatus 100. The display unit 106 is used in displaying a GUI for operating the information processing apparatus 100, a live view display while shooting, displaying a screen for reproducing a generated image file, and the like.

The operation input unit 107 may be various types of user interfaces provided in the information processing apparatus 100 such as an operation button, a switch, a mouse, a keyboard, and the like. Also, the display unit 106 and the operation input unit 107 may be integrally formed such as in a case of a touch panel and a touch panel sensor. When the operation input unit 107 detects that an operation has been input to the user interface, the operation input unit 107 outputs a control signal indicating this to the CPU 101.

The communication unit 108 is a communication interface with an external apparatus of the information processing apparatus 100. The communication unit 108, for example, may be a network interface for connecting to the network and transmitting and receiving transmission frames. In this case, the communication unit 108, for example, may be a PHY and MAC (transmitting media control processing) capable of a wired LAN connection via the Ethernet (registered trademark). Also, in a case in which the communication unit 108 is capable of connecting to a wireless LAN, the communication unit 108 may include a controller, an RF circuit, and an antenna for performing wireless LAN control based on IEEE 802.11a/b/g/n/ac/ax or the like.

The non-volatile memory 110, for example, is a non-volatile recording apparatus with a large storage capacity such as an SD card, CompactFlash (registered trademark), flash memory, and the like. The non-volatile memory 110 according to the present embodiment stores generated image files, image files obtained via the communication unit 108, and the like.

The information processing apparatus 100 according to the present embodiment generates a three-dimensional image file storing three-dimensional image data. Hereinafter, such three-dimensional image data may be simply referred to as “three-dimensional data”.

The information processing apparatus 100 according to the present embodiment, as described above, obtains metadata including region information relating to a partial region in a three-dimensional image, annotation information associated with the partial region, and condition information according to the viewpoint position or the view direction for whether or not to display the annotation information. Here, a region corresponding to an object in the three-dimensional image data is used as the partial region. Also, as the annotation information, text information displayed in association with an object is used. However, no such limitation is intended, and it is sufficient that the information is associated with a partial region.

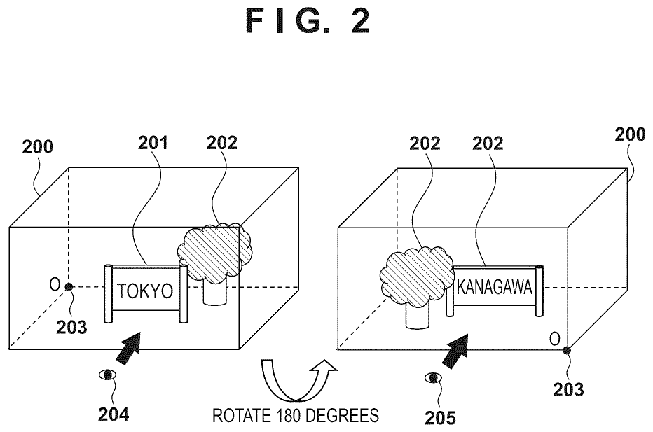

Also, as condition information, a viewpoint position range or view direction for displaying annotation information is set, and such condition information is associated with the annotation information or the partial region indicating the object. Various types of information set with respect to such three-dimensional data will be described below with reference to FIGS. 2 to 10.

FIG. 2 is a diagram for describing three-dimensional image data according to the present embodiment. In the example illustrated in FIG. 2, included in three-dimensional data 200, an object 201 (nameboard), an object 202 (tree), and a reference point 203 are recognized in the three-dimensional data 200. In the example of FIG. 2, annotation information displayed when the object 201 is viewed from a viewpoint 204 and annotation information displayed when the object 201 is viewed from a viewpoint 205 are separately provided to (associated with) the object 201.

Here, the viewpoint 204 and the viewpoint 205 indicate positions (ranges) corresponding to viewpoint positions that are conditions for displaying the corresponding annotation information. Here, the viewpoint 204 and the viewpoint 205 are illustrated as points, but this is merely an example. The condition information may be designated as a region or may be designated using a coordinate condition. A condition in which a viewpoint position is designated as a condition for displaying the annotation information (relating to display of the annotation information) may hereinafter be referred to as a “viewpoint condition (information)”. Note that the viewpoint 204 and the viewpoint 205 may be set in the region of the three-dimensional data or may be set outside the region.

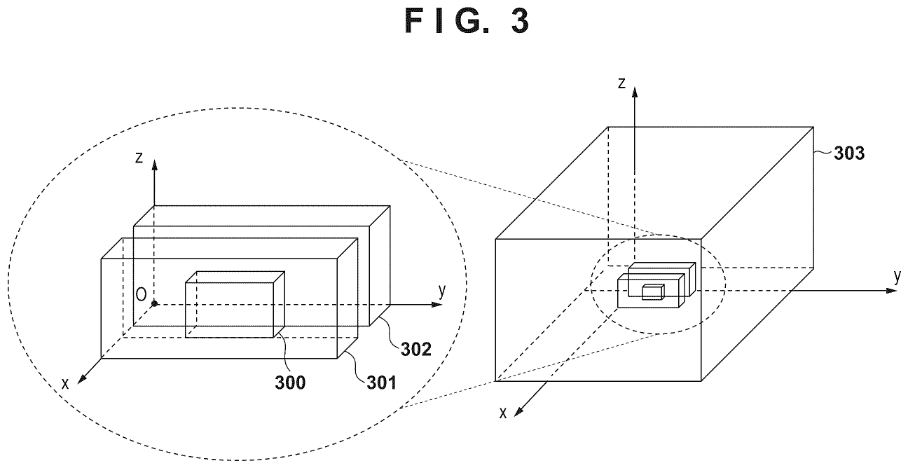

FIG. 3 is a diagram illustrating a three-dimensional region 300, which is a partial region indicating the object 201 in the three-dimensional data 200, and a three-dimensional region 301 and a three-dimensional region 302 (corresponding to the viewpoint 204 and the viewpoint 205 respectively) indicating the region of a viewpoint condition in a case where the region is set as the viewpoint condition. In the example of FIG. 3, each region is set as a cuboid region, but the shape is not particularly limited thereto, and it is sufficient that the shape can be set as a region. For example, each region may be set as a spherical region or as a planar region, for example.

In the example of FIG. 3, the regions of the three-dimensional region 301 and the three-dimensional region 302 are designated by the user as viewpoint condition information for setting different annotation information associated with the three-dimensional region 300 of the object 201. An example of a method for designating the region includes a method using “3DRegionSet” syntax indicating a three-dimensional region specified by MPEG, for example. But the method is not particularly limited, and it is sufficient that a region can be designated in a similar manner. Here, the annotation information in a case where the viewpoint position is included in the three-dimensional region 301 and the annotation information in a case where the viewpoint position is included in the three-dimensional region 302 are each set by the user. The CPU 101 according to the present embodiment stores the information relating to the partial region in the three-dimensional image in a three-dimensional image file as metadata.

Also, a three-dimensional region 303 is a wide three-dimensional region including all of the three-dimensional regions 300 to 302. A method of setting a condition so that different annotation information is displayed depending on whether the viewpoint position is inside the three-dimensional region 303 or outside the three-dimensional region 303 will be described below in detail. Also, in a case where the viewpoint position is not included in any of the three-dimensional region 301, the three-dimensional region 302 and the three-dimensional region 303, default annotation information may be set to be displayed.

The CPU 101 according to the present embodiment further stores the annotation information associated with the partial regions in a three-dimensional image file as metadata. Also, the CPU 101 stores the viewpoint condition information described above in a three-dimensional image file as metadata in association with the region information or the annotation information. Such processing by the CPU 101 will be described below. Note that as described above, a condition according to the viewpoint position and a condition according to the view direction exist as viewpoint conditions. However, in the example described below, the viewpoint condition according to a viewpoint position is used. An example using the view direction will be described in a second embodiment.

FIG. 4 is a flowchart illustrating an example of the processing for associating the default annotation information and annotation information according to the viewpoint position with an object recognized in three-dimensional data. The processing illustrated in FIG. 4 is executed by the CPU 101 in response to the input of an operation start operation by the user, for example.

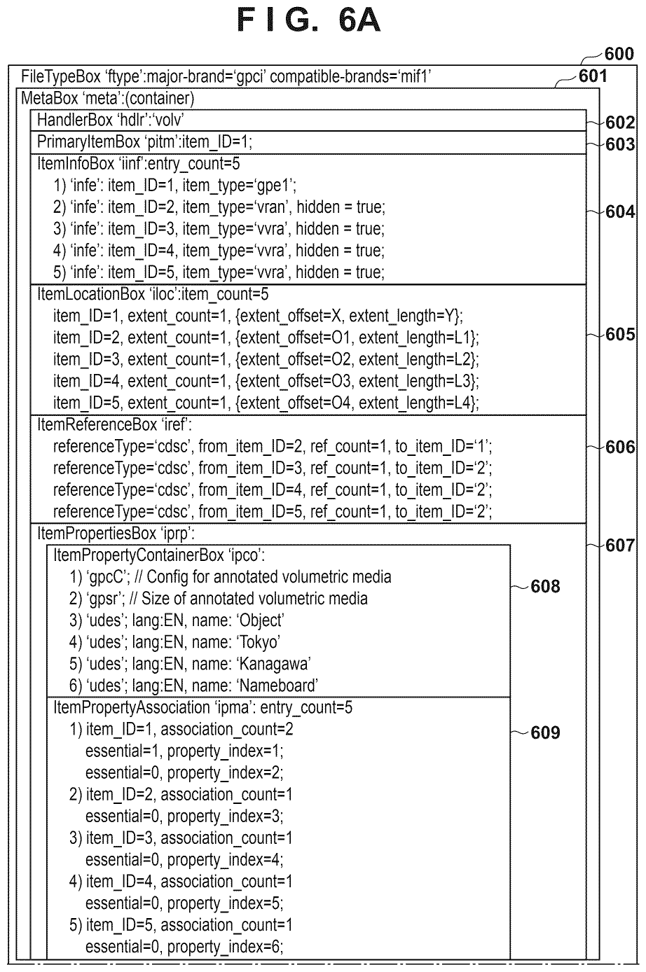

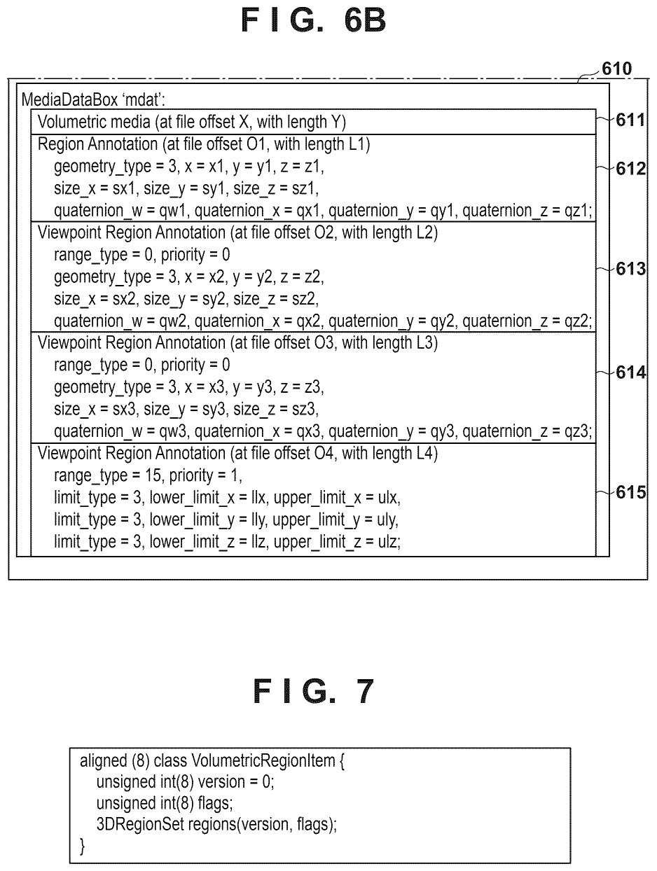

FIG. 4 is a flowchart illustrating an example of three-dimensional image file generation processing by the information processing apparatus 100. The processing corresponding to the flowchart is implemented by the CPU 101 by reading a program stored in the ROM 102 and loading the program on the RAM 103 to cause the blocks to operate. Note that the processing illustrated in FIG. 4 is executed by the CPU 101 in response to the input of an operation start operation by the user, for example. Each box in the file illustrated in FIG. 6A-6B will be described below.

In S401, the CPU 101 controls the imaging unit 104 or the image processing unit 105 and obtains three-dimensional image data to be stored in a file.

In S402, the recognition processing unit 114 executes processing for detecting an object in the three-dimensional image. Here, a predetermined specific object such as a person, a specific object, or the like is detected. As the recognition processing by the recognition processing unit 114, for example, matching processing based on reference image data of a specific object pre-registered may be executed, and detection processing to detect whether the object appears in the image may be executed. Also, here, processing including generating attribute information of the object may be executed in addition to the object detection processing. Also, as the processing for specifying the object may not only be detection processing from an image, but designation of a region of an object via a user input using a three-dimensional image editing application or the like may be used.

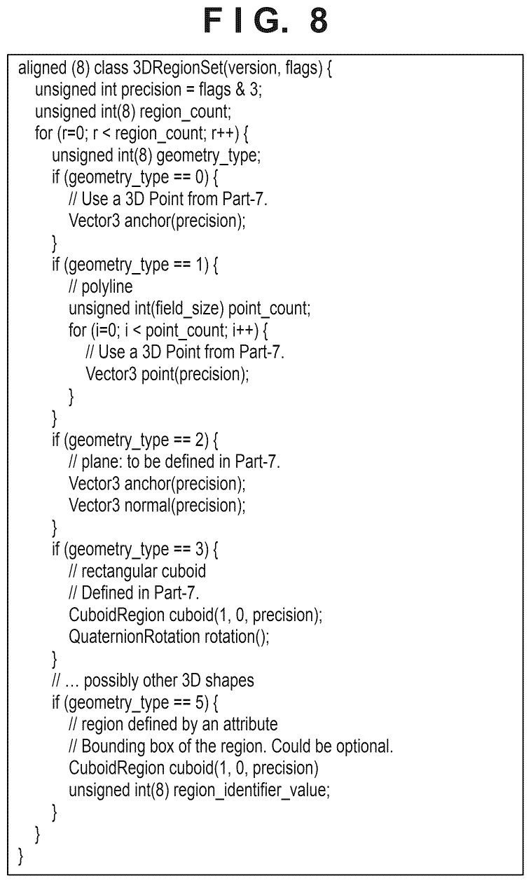

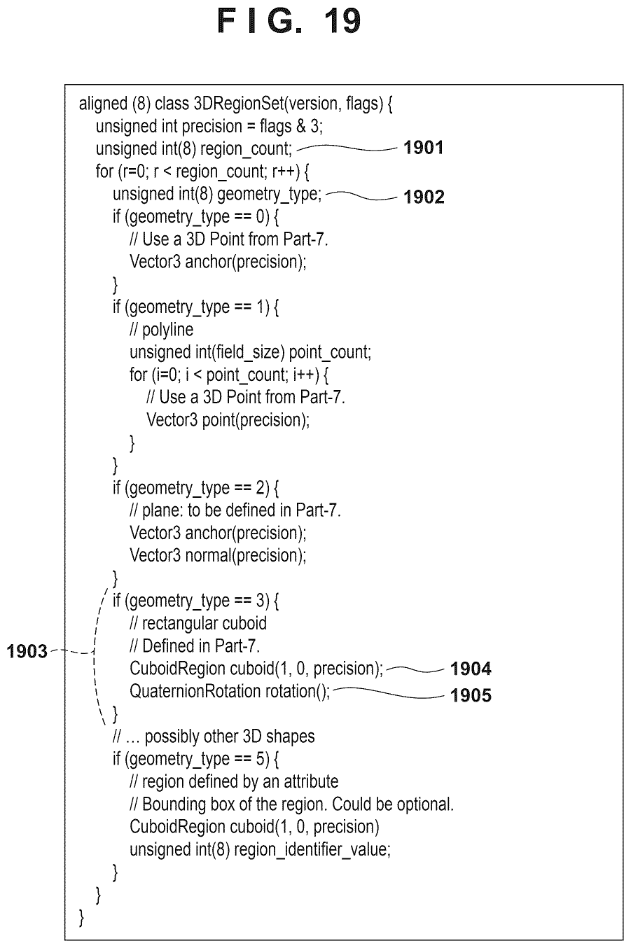

In S403, the generation unit 113 generates region information relating to the partial region indicating the object detected by the recognition processing unit 114 in the three-dimensional image. For example, as the region information, the 3DRegionSet structure illustrated in FIG. 8 or the 3DRegionSet illustrated in FIG. 19 may be generated. The generated region information is stored in the “mdat” box illustrated in FIG. 6B and is thus stored in an output buffer.

In S404, the CPU 101 determines whether or not to provide (associate) the annotation information to the partial region generated in S403. For example, in a case where attribute information of the object is generated in S402, whether to provide the attribute information as annotation information is determined. Here, if a determination of whether or not to provide the annotation information to the partial region (or corresponding object) which is the processing target is performed, the condition and the like can be discretionarily set. For example, whether or not providing predetermined annotation information (corresponding to the type of object, for example) to the detected object is preset may be determined. Also, the CPU 101 may obtain a user selection operation for whether or not to provide annotation information to the detected object and may perform determination of whether or not to associate the annotation information in response to the operation. In a case where it is determined to provide the annotation information, the processing advances to S405. Otherwise, the processing advances to S409.

In S405, the metadata processing unit 112 sets the annotation information to be associated with the partial region generated in S403. Here, the metadata processing unit 112, for example, may set the annotation information to be displayed for each viewpoint condition described below, may set the default annotation information to be displayed by default, and may generate the “ipco” box entry data described below as attribute information. The metadata processing unit 112 may receive a user input for setting the content of the annotation information (for example, text) and may set the annotation information on the basis of the user input.

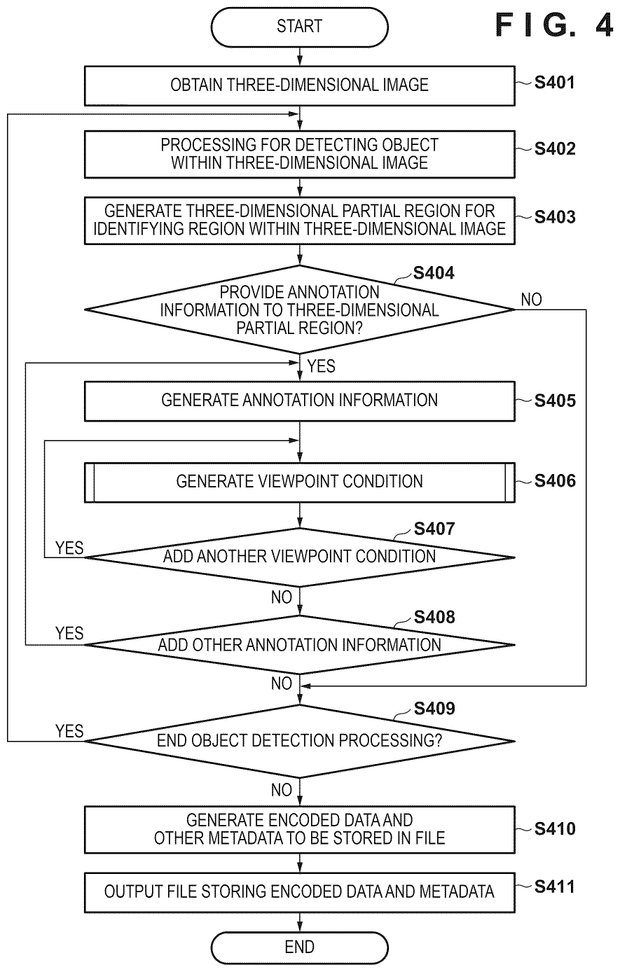

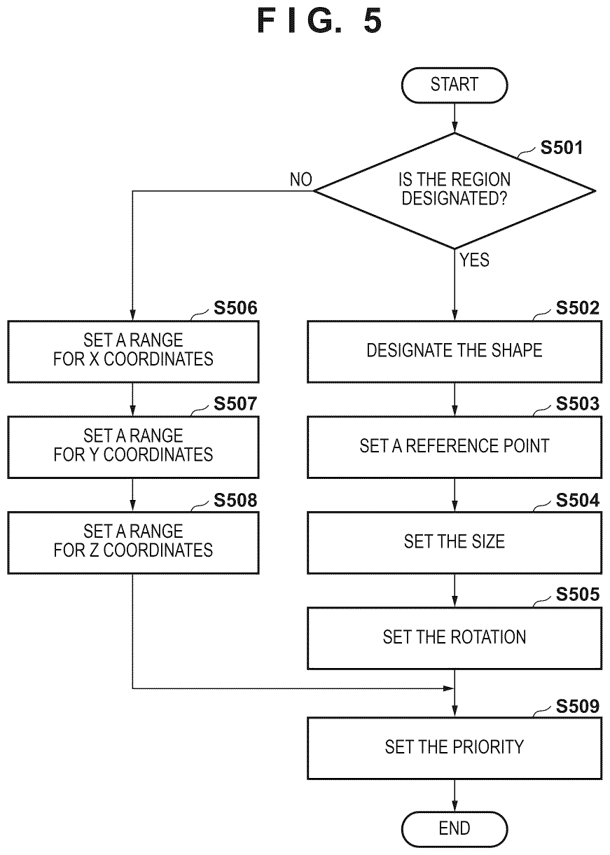

In S406, the metadata processing unit 112 sets the condition (viewpoint condition) indicating the condition relating to displaying the annotation information set in S405. S405 according to the present embodiment will be described below in detail with reference to FIG. 5.

In S407, the metadata processing unit 112 determines whether or not to add another viewpoint condition to the annotation information set in S405. In a case where another is to be added, the processing returns to S406. Otherwise, the processing advances to S408. Here, in a case where a user input indicating to add a viewpoint condition has been obtained, for example, determination to add another viewpoint condition may be performed.

In S408, the metadata processing unit 112 determines whether to associate the additional annotation information to the partial region generated in S403. In a case where the additional annotation information is to be associated, the processing returns to S405, and the processing from S405 to S407 is repeated. Via this loop processing, a plurality of pieces of annotation information can be associated with one partial region. Also, a plurality of pieces of information of annotation information display conditions (and virtual viewports used in the second embodiment) can be generated for each annotation information and stored in a file. In S408, in a case where additional annotation information is not to be associated, the processing advances to S409. Via the processing of S402 to S408, processing to associate annotation information with one partial region ends.

In S409, the metadata processing unit 112 determines whether to end object processing for detecting the three-dimensional image. In the case of ending processing, the processing advances to S410. Otherwise, the processing returns to S402.

In S410, the encoding/decoding unit 111 executes encoding processing on the three-dimensional image data and stores the encoded data in the output buffer. Also, the metadata processing unit 112 merges the metadata generated in the processing up to S406 and the metadata required to decode the encoded data, generates “meta” box structure data, and stores this in the output buffer.

In S411, the metadata processing unit 112 combines “ftyp” box information relating to the three-dimensional image file, “meta” box information storing the final metadata, and “mdat” box information storing items such as the encoded data and viewpoint condition information. Then, the CPU 101 writes the generated image file storing the combined metadata and image data from the RAM 103 to the non-volatile memory 110, stores the file, and ends the processing illustrated in FIG. 4.

Note that in the present embodiment described above, the three-dimensional image data stored in the three-dimensional image file is obtained by controlling the imaging unit 104 and the image processing unit 105. However, the data is not limited to this example, and it is sufficient that the data is data with which similar processing can be executed. For example, the three-dimensional image data may be an image pre-stored in the ROM 102 or the non-volatile memory 110 or may be an image received via the communication unit 108.

Next, the processing for setting the viewpoint condition information will be described with reference to FIG. 5. FIG. 5 is a flowchart illustrating in detail an example of the processing executed in S406 according to the present embodiment.

In S501, the CPU 101 determines whether to set the viewpoint condition information by designating the region or to set the viewpoint condition information by designating coordinates. For example, the CPU 101 may present to the user a display for selecting whether to designate a region or designate coordinates and perform the determination of S501 on the basis of the user input. In the case of the viewpoint condition information being set by designating a region, the processing advances to S502. In the case of the viewpoint condition information being set by designating coordinates, the processing advances to S506.

In S502, the metadata processing unit 112 sets the shape of the region (for display of the annotation information in a case where the viewpoint exists in the region) to be used as the viewpoint condition. Hereinafter, such a region used as a viewpoint condition may be simply referred to as a “condition region”. Here, as the shape of the region, for example, a dot, a line, a plane, a cuboid, a sphere, an ellipsoid, or the like may be used, and other shapes may be used. For example, the metadata processing unit 112 may set the shape (for example, a cuboid) of the condition region used by default and, in a case where an input to change the shape of the condition region has been received from the user, may re-set the shape of the condition region on the basis of the input.

In S503, the metadata processing unit 112 sets the position of a reference point of the condition region. The reference point is represented by three-dimensional coordinate information. The reference point here is not particularly limited, and it is sufficient that the coordinates can set the position of the condition region according to a predetermined rule. For example, in a case where the condition region is a cuboid, the reference point may be set as the coordinates of a predetermined vertex of the cuboid or as the coordinates of the center of the cuboid. In a case where the condition region is a sphere, an ellipsoid, or the like, the reference point may be set as the coordinates of the center of these shapes. The position of the reference point may be set as a predetermined position in a coordinate system in the three-dimensional image data or may be set on the basis of user input.

In S504, the metadata processing unit 112 sets the size of the condition region. The size of the condition region, for example, may be an initial size prepared according to the shape of the condition region or may be set on the basis of user input. In a case where the condition region is a cuboid, for example, the size of the condition region can be represented as offset information from the reference point. In a case where the condition region is a sphere, the size can be represented as the radius, and in a case where the condition region is an ellipsoid, the size can be represented as the radius in the X-axis, Y-axis, and Z-axis.

In S505, the metadata processing unit 112 sets the rotation amount from the reference attitude of the condition region. The rotation amount of the condition region can be separately set for X-axis rotation, Y-axis rotation, and Z-axis rotation. The rotation amount here is represented with a quaternion, but may be expressed using different parameters such as Euler angles, for example. After S505, the processing advances to S509.

In S506 to S508, the metadata processing unit 112 sets the coordinates (for display of the annotation information in a case where the viewpoint exists at the coordinates) to use as the viewpoint condition. Hereinafter, such coordinates used as a viewpoint condition may be simply referred to as “condition coordinates”. Here, as the condition coordinates, a range for X coordinates, Y coordinates, and Z coordinates are set, and the annotation information is displayed in a case where the viewpoint position satisfies all ranges. Note that as the condition coordinates, an upper limit, lower limit, or both for possible coordinates may be set. Also, as the condition coordinates, X coordinates, Y coordinates, and Z coordinates do not all need to be set, and it is sufficient that at least one of these is set. Here, the metadata processing unit 112 sets, as the condition coordinates, the X coordinates in S506, the Y coordinates in S507, and the Z coordinates in S508. The metadata processing unit 112, for example, can set the condition coordinates on the basis of user input. After S508, the processing advances to S509.

In S509, the metadata processing unit 112 sets the priority for the viewpoint conditions. Here, priority for the viewpoint conditions corresponds to, in a case where a plurality of viewpoint conditions are satisfied, information used to determine which annotation information corresponding to which viewpoint condition, from among the viewpoint conditions, to display. Here, as the priority, different numerical values (0 being the lowest) are provided to each viewpoint condition, and the annotation information corresponding to the viewpoint condition with the lowest value for the provided priority is displayed.

Note that in the example described here, only one piece of annotation information is displayed according to the priority, but a plurality of pieces of annotation information may be displayed. For example, the metadata processing unit 112 may select a predetermined number of viewpoint conditions in order of highest priority and may display all of the pieces of annotation information corresponding to the selected viewpoint conditions.

Also, in the example described above, the partial region and the condition region are set on the basis of user input. However, no such limitation is intended, and it is sufficient that these regions can be set as partial regions in the three-dimensional image data. For example, a region of an object recognized by typical object recognition processing may be obtained as a partial region.

FIG. 6A-6B are diagrams illustrating an example of the configuration of the generated file in the case of setting the annotation information described using FIGS. 4 and 5 for the object 201 using the three-dimensional data and the viewpoint condition information illustrated in FIGS. 2 and 3. A file 600 illustrates the entire three-dimensional image file. FileTypeBox at the top of the file stores a brand name for a reader to identify the file specification. MetaBox 601 (“meta”) is a box containing all of the information relating to the three-dimensional data and stores a plurality of boxes in a hierarchical structure. HandlerBox 602 (“hdlr”) stored at the top of the MetaBox 601 stores a handler type declaration for analyzing the structure of the MetaBox 601. In the present embodiment, the HandlerBox 602 stores the handler type “volv” for identifying the HandlerBox 602 as metadata with three-dimensional data as the target. PrimaryItemBox 603 (“pitm”) designates an identifier for a representative item in the file 600. The Primary ItemBox 603 according to the present embodiment stores item ID=1 of the three-dimensional data 200. ItemInfoBox 604 (“iinf”) stores information such as the item ID, the item type, or the like for all of the items included in the file 600. Item ID=1 is the three-dimensional data 200 illustrated in FIG. 2, and as the item type, “gpe1” indicating volume media is stored.

Item ID=2 is the three-dimensional region 300 illustrated in FIG. 3, and as the item type, “vran” indicating three-dimensional region annotation information (VolumetricRegionItem) is stored. The item format of the three-dimensional region annotation information is illustrated in FIG. 7. The three-dimensional region annotation information can store flags used when designating the position of a region and a plurality of three-dimensional region sets (3DRegionSet). The format of the three-dimensional region set is illustrated in FIG. 8. The three-dimensional region set can store three-dimensional regions of a plurality of different shapes. The number of three-dimensional regions stored is indicated by region_count. Also, the shape of the three-dimensional region is indicated by geometry_type. The shape of the three-dimensional region, for example, is a point if geometry_type is 0, a straight line if 1, a plane if 2, and a cuboid if 3. The information stored in the three-dimensional region set is different for each shape of the three-dimensional region, and in a case where the three-dimensional region is a cuboid, the reference point, size, and rotation information of the cuboid is stored.

Also, in the example of FIG. 6A-6B, in a case where geometry_type=5, the shape of the three-dimensional region is designated by the attribute information. Here, as the region information, as an option, cuboid and an attribute value defining a region (region_identifier_value) are designated. In a case where a cuboid is designated, the three-dimensional region is indicated by a bounding box.

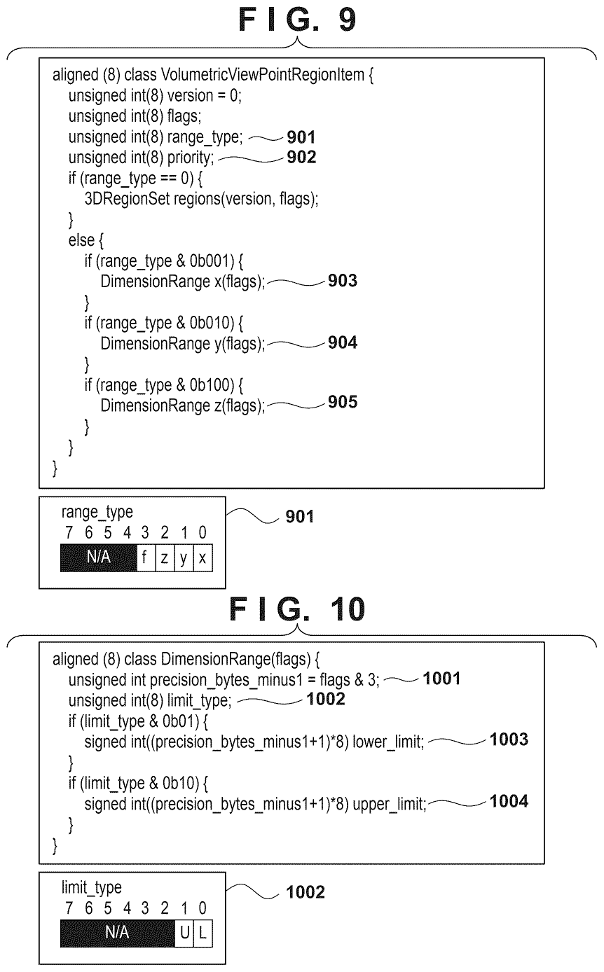

Item ID=3 is the three-dimensional region 301 illustrated in FIG. 3, and as the item type, “vvra” indicating viewpoint condition information (Volumetric ViewPointRegionItem) is stored. An example of the viewpoint condition information format definition is illustrated in FIG. 9. The viewpoint condition information includes a case where a region of the viewpoint position is designated and a case where a coordinate condition of the viewpoint position is designated. range_type 901 is an item with the lower 4 bits being an effective value, and if all of the bits are 0, this indicates that the region of the viewpoint position is designated. In the case of the region of the viewpoint position being designated, the three-dimensional region set (3DRegionSet) described in FIG. 8 is subsequently stored. In the case of the coordinate condition of the viewpoint position being designated, at least 1 bit of the 0 to 2 bits (x, y, z) of the range_type 901 must be 1. The values of the 0 to 2 bits indicate whether or not to designate the range of the X coordinates, the range of the Y coordinates, and the range of the Z coordinates, respectively. For example, if the values of the 0 to 2 bits are 5(0b101), this indicates that the range of the X coordinates and the range of the Z coordinates are subsequently stored. The third bit (f) indicates whether the condition to be used in setting the coordinates range is and AND condition (f=1) or an OR condition (f=0). In a case where the condition to be used in setting the coordinates range is an AND condition and the conditions of the coordinates range designated for the viewpoint are all true, the viewpoint condition is determined to be true. In a case where the condition to be used in setting the coordinates range is an OR condition and even one of the conditions of the coordinates range designated for the viewpoint are true, the viewpoint condition is determined to be true.

priority 902 stores the priority to be set in S509 of FIG. 5. In the case of the viewpoint condition information being designated by a coordinate condition of the viewpoint position, DimensionRange (903 to 905) are subsequently stored as dimension coordinates range information designated in the range_type 901. An example of the dimension coordinates range format definition is illustrated in FIG. 10. An item 1001 (precision_bytes_minus 1) determines what bits to use to express the upper limit and the lower limit of the coordinates range designation described below. The upper limit and the lower limit of the coordinates range designation, for example, may be determined by selection from one of 8 bits, 16 bits, 24 bits, and 32 bits.

limit_type 1002 is an item with the lower 2 bits being an effective value, and at least 1 bit of the 0 to 1 bits (L and U) must be 1. The 0 to 1 bits indicate whether or not to designate the lower limit value and the upper limit value of the dimension coordinates, respectively. For example, if the value of the 0 to 1 bits is 2 (0b10), this indicates that the upper limit value is subsequently stored, and if the value of the 0 to 1 bits is 3 (0b11), this indicates that the upper limit value and the lower limit value are subsequently stored.

Item ID=4 is the three-dimensional region 302 illustrated in FIG. 3, and as with item ID=3, as the item type, “vvra” indicating viewpoint condition information is stored. Item ID=5 is the three-dimensional region 303 illustrated in FIG. 3, and as with item ID=3 and 4, as the item type, “vvra” indicating viewpoint condition information is stored.

Item LocationBox 605 (“iloc”) stores information indicating the storage place of each item starting with the three-dimensional data in the file 600. Via the information of the ItemLocationBox 605, the location in the file 600 of the three-dimensional data stored in MediaDataBox 610 described below, three-dimensional region information, the viewpoint condition information, and the like can be identified.

ItemReferenceBox 606 (“iref”) stores information describing the association between items included in the file 600. The association between items is performed by designating the item reference type, with this allowing the type of the item reference to be identified. Also, the reference relationship between each item is described by the item ID designated to from_item_ID and to_item_ID in ItemInfoBox 604 being described. In the present embodiment, item ID=2 (three-dimensional region 300) is associated with item ID=1 (three-dimensional data 200). Also, item ID=3 (three-dimensional region 301), item ID=4 (three-dimensional region 302), and item ID=5 (three-dimensional region 303) are associated with item ID=2 (three-dimensional region 300).

ItemPropertiesBox 607 (“iprp”) stores each type of attribute information (item property) for the items included in the file 600. The ItemPropertiesBox 607 further includes ItemPropertyContainerBox 608 (“ipco”) describing the attribute information and ItemProperty Association 609 (“ipma”) indicating the association between the attribute information and each item.

In the present embodiment, as a property provided to Item ID=1 (three-dimensional data 200), “gpcC” indicating settings of the three-dimensional data and “gpsr” indicating the size of the three-dimensional data are stored. “udes” means UserDescriptionProperty and is attribute information that can store any text information. In the present embodiment, the annotation information for the three-dimensional region is set using “udes”.

In the present embodiment, as the default annotation information provided to item ID=2 (three-dimensional region 300), “Object” is stored. Also, as the annotation information provided to item ID=3 (three-dimensional region 301), “Tokyo” is stored. As the annotation information provided to item ID=4 (three-dimensional region 302), “Kanagawa” is stored. As the annotation information provided to item ID=5 (three-dimensional region 303), “Nameboard” is stored.

In the MediaDataBox 610 (“mdat”), each item data is stored at the location designated in the ItemLocationBox 605. Volumetric Media 611 is encoded data of the three-dimensional data 200. Region Annotation 612 is three-dimensional region annotation information of the three-dimensional region 300.

Viewpoint Region Annotation 613 is viewpoint condition information of the three-dimensional region 301 and is designated as a region of the viewpoint position (in a case where range_type=0). Here, the viewpoint condition of the three-dimensional region 301 is set as the highest priority (priority=0). The region shape is a cuboid (geomerty_type=3), with the size and rotation information set.

Viewpoint Region Annotation 614 sets the viewpoint condition information in a similar format to the Viewpoint Region Annotation 613. Viewpoint Region Annotation 615 is viewpoint condition information of the three-dimensional region 303 and is designated as a coordinate condition of the viewpoint position (in a case where range_type=15(0b1111)). Here, the viewpoint condition of the three-dimensional region 303 has the upper limit and the lower limit set for the range of the X coordinates, the Y coordinates, and the Z coordinates.

According to this configuration, the encoded data of a three-dimensional image and metadata corresponding to the encoded data of the three-dimensional image including region information relating to a partial region in the three-dimensional image, annotation information associated with the partial region, and condition information indicating a viewpoint condition can be obtained, and a three-dimensional image file storing these can be generated. In particular, a three-dimensional image file can be generated so that the display mode of the annotation information according to the viewpoint position is different for any three-dimensional region of the three-dimensional data.

### Second Embodiment

In the first embodiment described above, the annotation information is displayed in a case where the viewpoint position satisfies a predetermined viewpoint condition. In the second embodiment described here, the annotation information is displayed in a case where the view direction satisfies a predetermined condition. The information processing apparatus 100 according to the present embodiment has basically the same configuration as that of the first embodiment and similar processing can be executed. Thus, redundant descriptions will be omitted.

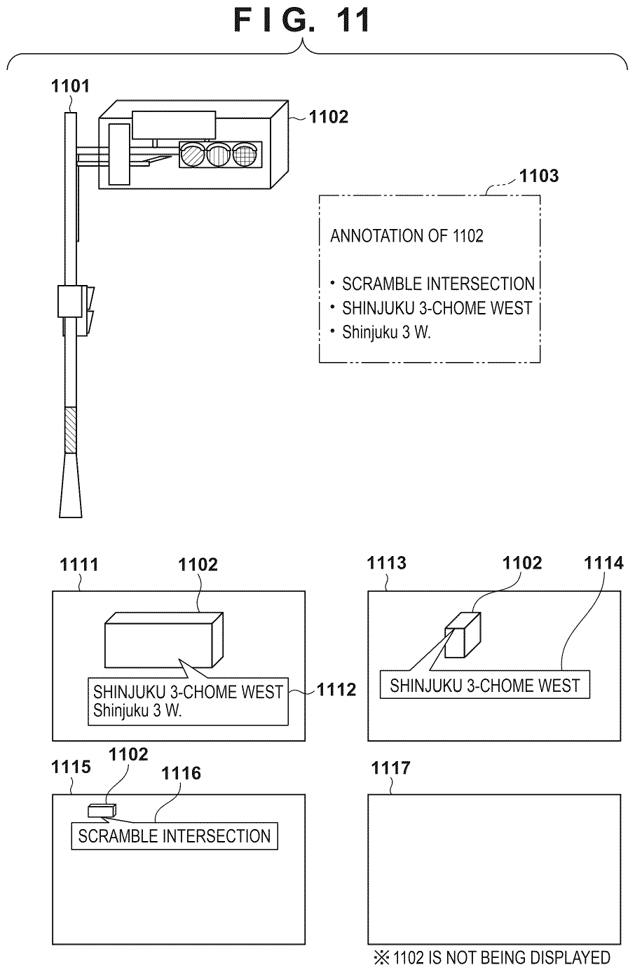

Display of annotation information according to different view directions in a three-dimensional image by the information processing apparatus 100 according to the present embodiment will now be described with reference to FIG. 11. An image 1101 of FIG. 11 illustrates a three-dimensional image of a traffic light installed at an intersection of a road in Japan. A three-dimensional region 1102 represents a three-dimensional partial region containing a three-light lamp device and an information sign included in the traffic light of the image 1101. Annotation information 1103 is annotation information associated with the three-dimensional region 1102. The annotation information 1103 indicates that three pieces of annotation information, “Scramble Intersection”, “Shinjuku 3-Chome West”, and “Shinjuku 3 W.”, are associated with the three-dimensional region 1102.

Viewports 1111, 1113, 1115, and 1117 of FIG. 11 are viewports that are display screens of the three-dimensional image of the traffic light. These viewports are four patterns of viewports including examples of the annotation information being displayed in association with the display of a partial region of the three-dimensional region 1102 and an example of annotation information not being displayed. The viewports according to the present embodiment represent a projection range of the three-dimensional image on a display plane as seen from a specific viewpoint in the three-dimensional space.

The viewport 1111 is a viewport in a case where the viewpoint position is a close distance from the position of the traffic light in the three-dimensional coordinate space of the traffic light image. In the viewport 1111, the three-dimensional region 1102 is displayed in the viewport, and two pieces of annotation information 1112, “Shinjuku 3-Chome West” and “Shinjuku 3 W.” are displayed as captions. The viewport 1113 is a viewport from a viewpoint position separated from the traffic light a little bit more than in the example of the viewport 1111 in the same three-dimensional space. In the viewport 1113, the three-dimensional region 1102 is displayed, and only annotation information 1114 “Shinjuku 3-Chome West” is displayed. In the viewport 1111 and the viewport 1113, the view direction (relative angle from the traffic light) is different in addition to the viewpoint position. The viewport 1115 is a viewport from a viewpoint position located a good distance farther away from the traffic light than in the example of the viewport 1113. The viewport 1115 displays the three-dimensional region 1102 in a smaller size than in the example of the viewport 1111. In the viewport 1115, annotation information 1116 “Scramble Intersection” is displayed. In the viewport 1117, neither the three-dimensional region 1102 nor the annotation information is displayed in the viewport.

In this manner, consider a case in which whether or not an object indicated by a three-dimensional region fits in a viewport for actual display changes depending on the view direction in addition to the viewpoint position. Taking into account changes in the displayed content according to the view direction, on the basis of the view direction, the information processing apparatus 100 according to the present embodiment can perform display of the annotation information in a case where the object fits in the image (viewport) for actual display and not display the annotation information (or perform display of different annotation information) if this is not the case.

Though not illustrated in FIG. 11, on the basis of the view direction, in a case where the three-dimensional region 1102 is not displayed in the viewport, an arrow graphic indicating the direction in which the three-dimensional region 1102 exists in the three-dimensional space may be displayed in the viewport as annotation information.

As described above, the information processing apparatus 100 according to the present embodiment uses a condition designating a view direction as the viewpoint condition instead of a condition designating a viewpoint position (or in addition to a condition designating a viewpoint position). In the present embodiment, the three-dimensional image file stores data including the three-dimensional region information and the annotation information together with virtual viewport information (AnViewport) and viewpoint condition information. Also, the metadata is stored with the virtual viewport information and the annotation information associated together.

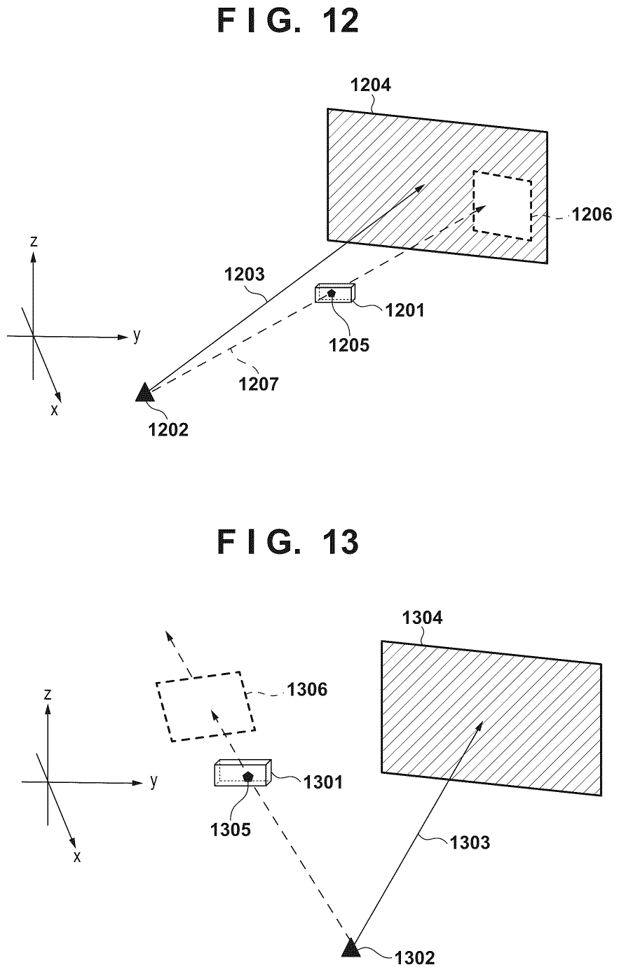

The viewpoint condition according to the present embodiment can be treated the same as the viewpoint condition according to the first embodiment except that instead of the condition designating a viewpoint position, a view direction is designated. An example using a viewpoint condition according to the present embodiment will be described below with reference to FIG. 12.

In FIG. 12, a three-dimensional region 1201 exists as a partial region indicating an object in three-dimensional data, and a viewpoint 1202 is illustrated as a viewpoint position and an arrow line 1203 is illustrated as the view direction from the viewpoint 1202. A viewport 1204 represents a display screen when a three-dimensional image is reproduced with the viewpoint set to the viewpoint 1202. Also, a reference point 1205 is a reference point for when the three-dimensional region 1201 is set and is the center point of the three-dimensional region 1201, a cuboid, in this example. Also, a virtual viewport 1206 is a region virtually generated in the object (reference point 1205) direction from the viewpoint 1202 and is set as a region assumed as a projection image of the object to the viewport 1204. A dashed line 1207 is a line indicating the direction from the viewpoint 1202 to the reference point 1205. Here, in a case where the dashed line 1207 passes through the viewport 1204, annotation information associated with the three-dimensional region is displayed on the viewport 1204 as it is considered that the object of the three-dimensional region 1201 is to be displayed in the viewport 1204.

In the present embodiment, the viewpoint position and the viewpoint direction can be changed by a user operation. When reproducing the three-dimensional image, the content projected on the display screen may also change in response to the viewpoint position in the three-dimensional space, the view direction, or the position or inclination of the viewport via rotation being changed. Here, in a case where a change in the view direction is performed, the viewport 1204 and the virtual viewport 1206 may vary together. Such an example will now be described with reference to FIG. 13.

As in FIG. 12, in FIG. 13, a three-dimensional region 1301 exists as a partial region indicating an object in three-dimensional data, and a viewpoint 1302 is illustrated as a viewpoint position and an arrow line 1303 is illustrated as the view direction from the viewpoint 1302. Also, in FIG. 13, a viewport 1304, a reference point 1305, and a virtual viewport 1306 are illustrated in a similar manner to the viewport 1204, the reference point 1205, and the virtual viewport 1206 in FIG. 12. In FIG. 12, the dashed line 1207 passes through the viewport 1204. However, in FIG. 13, the dashed line extending from the viewpoint 1302 to the reference point 1305 does not pass through the viewport 1304. Thus, the CPU 101 can be configured to not display the annotation information in such a case.

In the examples of FIG. 12 and FIG. 13, in a case where the straight line from the viewpoint position to the object (reference point of the partial region) passes through the viewport set as a predetermined range according to the view direction, the annotation information is displayed. In this manner, the information processing apparatus 100 according to the present embodiment may set the viewpoint condition so that whether to display the annotation information is determined according to the view direction. Here, the information processing apparatus 100 can set the viewpoint condition so that the annotation information is displayed in a case where the relationship between the view direction and a direction from the viewpoint to the three-dimensional region (object) satisfies a predetermined relationship. The predetermined relationship may correspond to a case such as that illustrated in FIG. 3 where the dashed line 1207 passes through the viewport 1204, which is a predetermined range with the view direction as the center, may correspond to a case where an angle between the arrow line 1203, which is the view direction, and the dashed line 1207 is within a predetermined angle (for example) 30°, and may be discretionarily set.

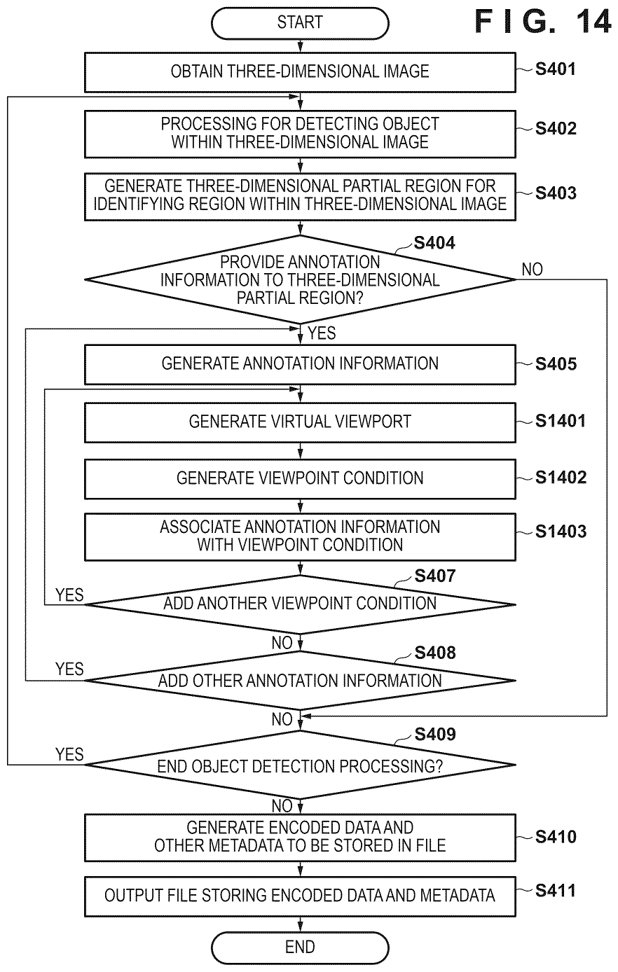

FIG. 14 is a flowchart illustrating an example of three-dimensional image file generation processing by the information processing apparatus 100 according to the present embodiment. The processing of FIG. 14 is similar to the processing illustrated in FIG. 4 of the first embodiment except that S1401 to S1403 are performed instead of S406. Thus, redundant description will be omitted.

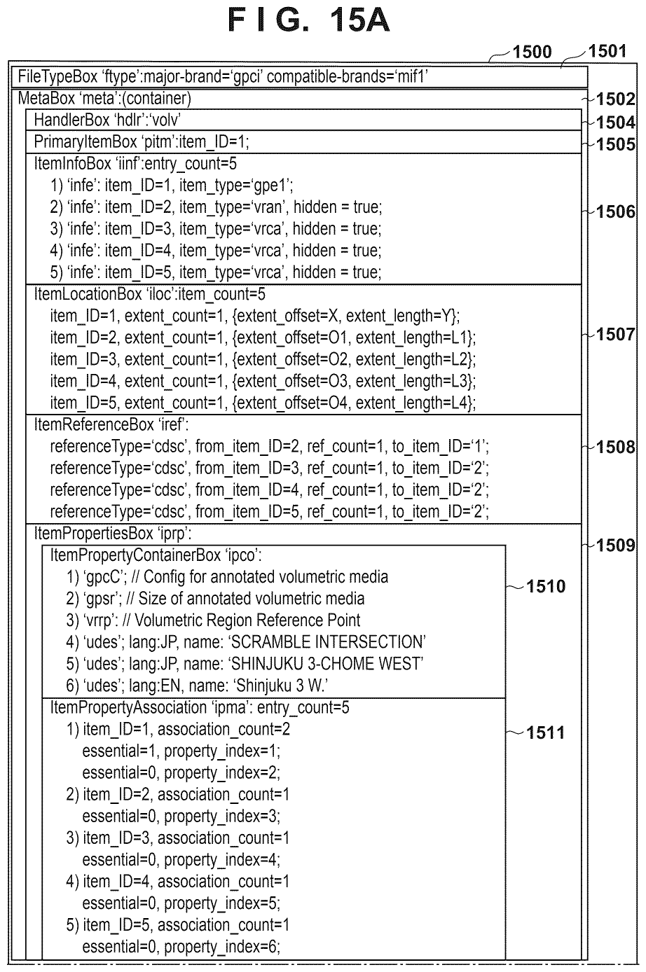

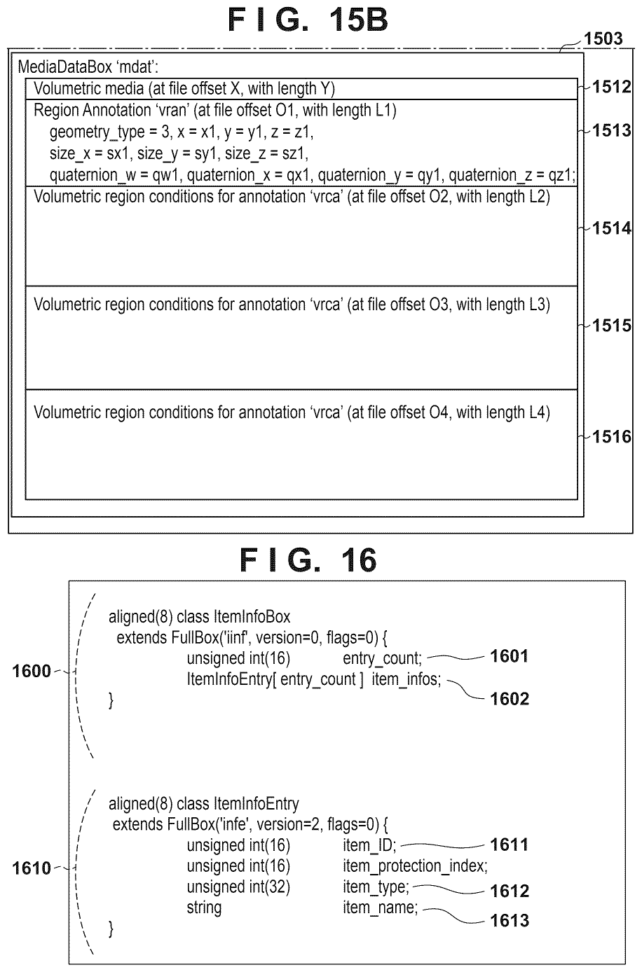

In S1401, the metadata processing unit 112 generates information of a virtual viewport corresponding to the annotation information set in S405. Here, the metadata processing unit 112 generates information of a reference point of a partial region as data of item attribute information stored in “ipco” box 1510 in the example of FIG. 15A described below. Also, the generation unit 113 generates information of a virtual viewport as data of AnViewport data structure of FIG. 15A-15B.

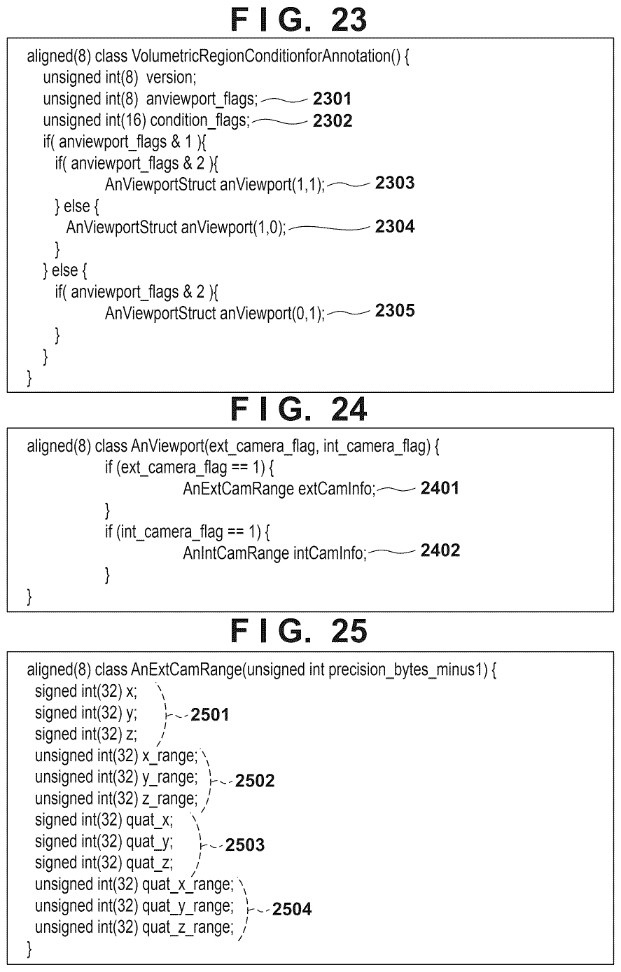

In S1402, the generation unit 113 generates an item of viewpoint condition information designating a view direction. Here, the generation unit 113 generates viewpoint condition information as data of VolumetricRegionConditionforAnnotation structure data of FIG. 13. The viewpoint condition information according to the present embodiment includes viewport information for selection of annotation information generated in S1401. Also, the generation unit 113 sets a flag value indicating the condition relating to display of the annotation information set in S405 in condition_flags (1302) illustrated in FIG. 23 described below. The generation unit 113 stores the data of the generated annotation information display condition information in an output buffer for storage in an “mdat” box 1503.

In S1403, the metadata processing unit 112 generates data for associating the annotation information set in S405 as attribute information of the viewpoint condition information item generated in S1402, and then the processing advances to S407. Specifically, the metadata processing unit 112 generates data for associating together the entry of the “ipco” box 1510 where the annotation information set in S405 is input and the item ID of the viewpoint condition information generated in S1402. The data for associating the attribute information is entry data stored in “ipma” box 1511.

FIG. 15A-15B are diagrams illustrating an example of the configuration of the file generated when the processing illustrated in FIG. 14 is executed using the three-dimensional data and the viewpoint condition information illustrated in FIGS. 12 and 13. Here, the three-dimensional image data illustrated in FIG. 12 is stored in a file, and one three-dimensional image, one partial region, and three pieces of annotation information associated with the partial region are included. The file configuration illustrated in FIG. 15A-15B includes content that is the same as in the file configuration illustrated in FIG. 5 of the first embodiment. Thus, redundant description will be omitted.

A file 1500 illustrated in FIG. 15A-15B illustrates the entire three-dimensional image file. MetaBox 1502 (“meta”) is a box containing all of the information relating to the three-dimensional data and having basically the same function as the MetaBox 601. MetaBox 1502 of FIG. 15A includes HandlerBox 1504, PrimaryItemBox 1505, ItemInfoBox 1506, ItemLocationBox 1507, ItemReferenceBox 1508, and ItemPropertiesBox 1509. The FileTypeBox 1501 (“ftyp”) stores a brand name for a reader to identify the image file specification. In the example of FIG. 15A, in the “ftyp” box, “gpci” is described as the brand name and “mif1” is described as a compatible brand name.

The ItemInfoBox 1506 (“iinf”) defines the item ID or item type of each item in the image file. Description 1600 in FIG. 16 indicates the “iinf” box structure. The description 1600 includes entry_count 1601 indicating the number of elements of the file and a ItemInfoEntry data array 1602. In the example of FIG. 15A-15B, the file includes five items. Thus, the entry_count 1601 is 5. Also, description 1610 of FIG. 16 indicates the ItemInfoEntry structure. The description 1610 includes, as each element of the data array, item_ID 1611 indicating the item ID, item_type 1612 indicating the item type, and item_name 1613 indicating the item name parameter. As indicated here, the G-PCC three-dimensional point group image item type is “gpe1”, the three-dimensional region information item type is “vran”, and the viewpoint condition information item type is “vrca”.

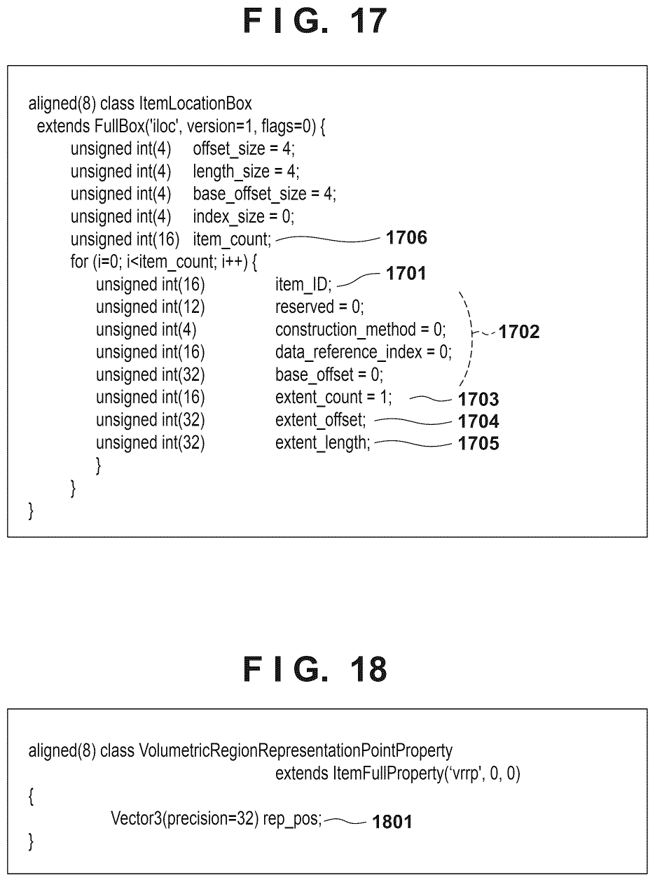

The ItemLocationBox 1507 (“iloc”) includes information indicating the storage place of the data of each item such as an image in the file. An example of the structure of the “iloc” box according to the present embodiment is illustrated in FIGS. 17. 1701 to 1705 illustrated in FIG. 17 are information specifying the location in the file where the item data exists. Also, item_count 1706 indicates the number of items. In description 1700, the item data corresponding to item_ID 1701, via the information indicated in description 1702, indicates that the place of the item data is represented by a byte offset from the top in the file. Also, description 1703 indicates that there is one piece of item data, description 1704 indicates the offset position, and description 1705 indicates the data length. The file 1500 stores five pieces of item data in “mdat”. Thus, the value of the item_count 1706 of “iloc” is 5, and five sets of parameters from 1701 to 1705 are included.

The ItemPropertiesBox 1509 (“iprp”) includes the items ItemPropertyContainerBox 1510 (“ipco”) and ItemPropertyAssociationBox 1511 (“ipma”). In the “ipco” box, the data of various attribute information (properties) are described in a list. Also, the “ipma” box describes information associating the attribute information and the items. In the “ipma” box, one piece of attribute information described in the “ipco” box may be described in association with a plurality of items.

The “ipco” box, for example, includes information indicating the width and height per unit pixel of the image item, data of a parameter set required to decode the encoded data of the three-dimensional image, or the like. The “ipco” box according to the present embodiment can store the reference point of the partial region as the attribute information of the three-dimensional region. In the file format illustrated in FIG. 15A-15B, an entry (“vrrp”) of coordinate data of the reference point of the partial region is stored in the “ipco” box, and information of the association with the item ID of the three-dimensional region information is stored in the “ipma” box.

An example of the structure of VolumetricRegionRepresentationPointProperty (“vrrp”), which is attribute information of the reference point of the partial region, is illustrated in FIG. 18. rep_pos 1801 is Vector3 data describing the coordinates of the Cartesian coordinate system of the reference point of the partial region. The data structure of Vector3 is illustrated in FIG. 21.

Also, in the example of FIG. 15A, the three pieces of annotation information (“udes”) are described as attribute information associated with each viewpoint condition information item. Here, the description of the annotation information uses UserDescriptionProperty (“udes”) as defined in ISO/IEC 23008-12.

MediaDataBox 1503 (“mdat”) includes three-dimensional image encoded data 1512, three-dimensional region information 1513, and viewpoint condition information 1514, 1515, and 1516. As described above, via the information specifying the location in the file where the data of the item in “iloc” exists, the image item and the in-file storage place of each item data in “mdat” are associated.

Region Annotation, which is the encoded data 1512, is encoded data of the G-PCC three-dimensional point group image item.

The three-dimensional region information 1513 has the 3DRegionSet structure illustrated in FIG. 19 and stores three-dimensional region information item data. In the three-dimensional region information illustrated in FIG. 19, one or more partial region shapes can be defined. region_count 1901 indicates the number of partial regions defined in the data, and in the example of FIG. 19, the number of regions is 1. geometry_type 1902 is a numerical value meaning the shape type of the partial region. In the example of FIG. 19, the partial region shape is a cuboid, and the value of the geometry_type 1902 is “3” corresponding to a cuboid.

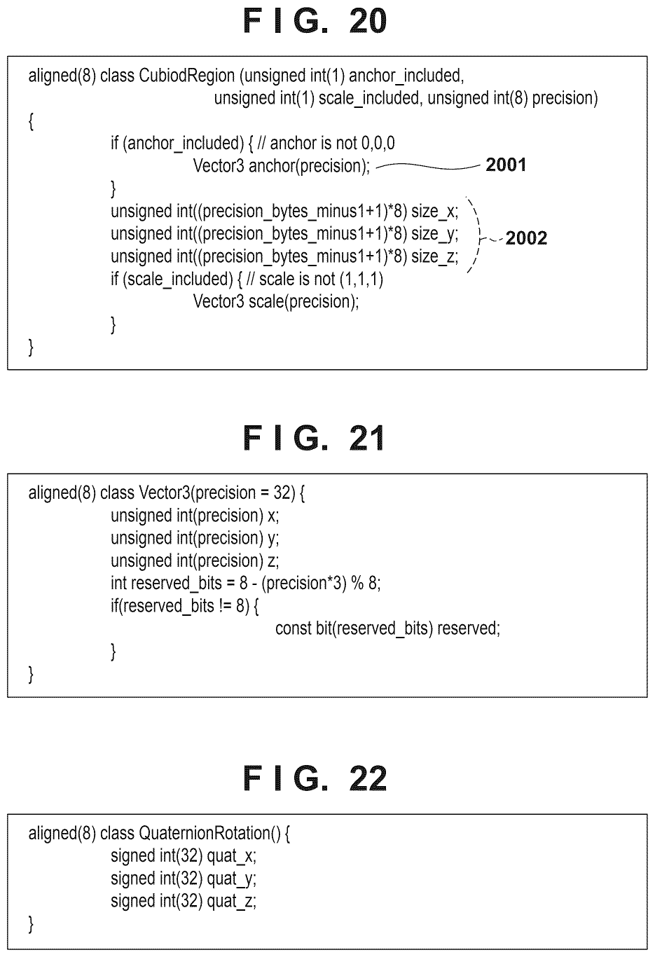

Also, in description 1903, the detailed shape of the cuboid of the partial region is described. cuboid 1904 is CuboidRegion data indicating the position and size of the cuboid partial region. An example of the structure of the CuboidRegion data is illustrated in FIG. 20. anchor 2001 in FIG. 20 is Vector3 data and describes the positional coordinates of the cuboid. size_x, size_y, and size_z indicated in description 2002 are the length of three sides of the cuboid of the partial region along the x-axis direction, y-axis direction, and z-axis direction of the Cartesian coordinate system. Also, the data structure of the CuboidRegion illustrated in FIG. 20 includes a flag (anchor_included) indicating whether an anchor is included, a flag (scale_included) indicating whether a scale is included, and precision. In the example of FIG. 20, the configuration includes an anchor (a point designating a region). Thus, an anchor_include flag is designated as 1, and the positional coordinates of the cuboid forming the region is designated. With the configuration, it is sufficient that the positional coordinates indicate the position of the cuboid, and for example, a vertex (for example, the back upper left in a left hand model or the front lower right in a right hand model), a center point, or the like specified in advance may be used.

Also, rotation 1905 of FIG. 19 is QuaternionRotation data for indicating the rotation of the cuboid three-dimensional partial region using quaternion representation. An example of the structure of the QuaternionRotation data is illustrated in FIG. 22. As illustrated in FIG. 22, the x component, y component, and z component of the quaternion representation are described using real number values. Note that one more component of the quaternion, the w component, can be calculated via a specified calculation using the values of the x component, y component, and z component.

The description indicated in 1514 to 1516 in FIG. 15B indicates the data of the viewpoint condition information items. Each piece of data is stored using the VolumetricRegionConditionforAnnotation structure of FIG. 23. The data structure illustrated in FIG. 23 includes virtual viewport information (AnViewport) of one of 2303 to 2035 via a flag value of anviewport_flags 2301. Here, the flag value of the anviewport_flags 2301 is either 1, 2, or 3. Also, the data structure illustrated in FIG. 23 includes a flag value of condition_flags 2302. Via the bit flag indicated by the condition_flags 2302, when the image file is reproduced, the display on the viewport of the annotation information associated with the viewpoint condition information is controlled.

Next, an example of the data structure of the virtual viewport information (AnViewport) is illustrated in FIGS. 24 to 26. FIG. 24 illustrates an example of the structure of AnViewport. AnViewport data includes extCamInfo 2401, which is range data of external camera information, intCamInfo 2402, which is information of internal camera information, or both.

The range data of the external camera information indicates the range of the viewpoint position and the range of the view direction when the three-dimensional image file is reproduced. Here, the range data of the external camera information is stored in the AnExtCamRange structure illustrated in FIG. 25. In FIG. 25, the range of the viewpoint position is described by the coordinates indicated in description 2501 and each range of the x, y, and z axis directions of 2502 from the coordinate position. On the other hand, the view direction is described by real number values of the x component, y component, and z component of the quaternion representation indicated in description 2503 and the real number range of each component of description 2504 based on the direction required by the description 2503. Note that the range of one more component of the quaternion, the w component, can be calculated via a predetermined calculation using the values of the x component, y component, and z component.

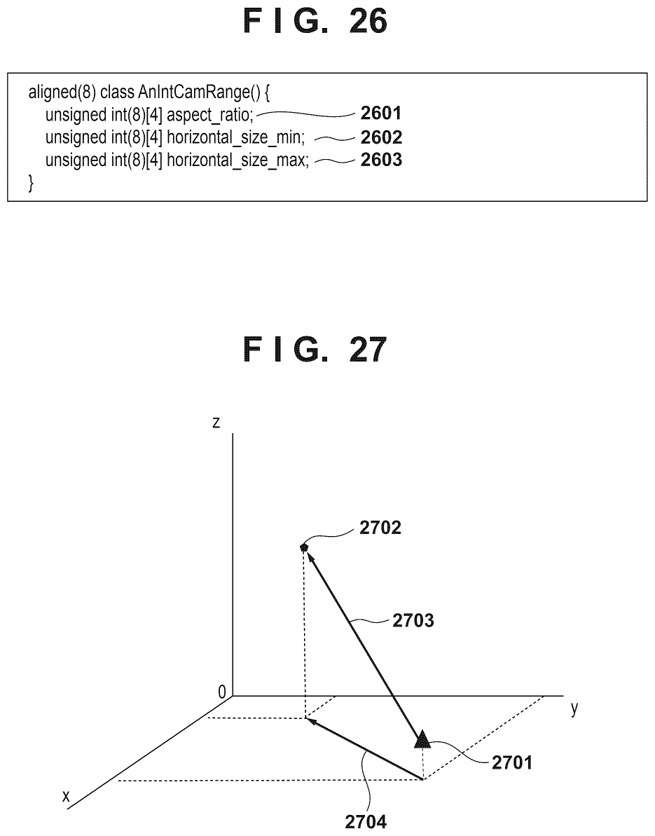

The range data of the internal camera information included in the AnViewport data structure is a range of the size of the virtual viewport, and such information is stored in the AnIntCamRange structure illustrated in FIG. 26. In FIG. 26, a vertical direction/horizontal direction aspect ratio 2601 of the virtual viewport, a minimum value 2602 of the length in the horizontal direction, and a maximum value 2603 of the length in the horizontal direction are described. For example, in a case where the aspect ratio is 0.75 and the length in the horizontal direction ranges from 512 to 1024, the length in the vertical direction ranges from 384 to 768.

Note that the condition_flags 2302 of the VolumetricRegionConditionforAnnotation data structure of FIG. 23 includes a flag for whether or not to display the annotation information when the three-dimensional region is included in the virtual viewport. Also, the condition_flags 2302 includes a flag for setting whether or not the three-dimensional region being included in both the virtual viewport and the viewport as a condition for displaying the annotation condition. Also, in a case where a plurality of pieces of annotation information are associated with the same partial region, to execute display control of such annotation information, information of display priority may be set for each piece of annotation information. Also, in a case where a plurality of reference points are associated with the three-dimensional region, the condition_flags 2302 may set viewpoint condition information including reference points of all of the partial regions in the virtual viewport and may include, as a flag, a display condition for displaying the annotation information via a determination using the viewpoint condition. Also, in a case where a plurality of reference points are associated with the three-dimensional region, the condition_flags 2302 may set viewpoint condition information so that the annotation information is displayed in a case where the greatest number of reference points of partial regions is included in the virtual viewport from the viewpoint position and may include, as a flag, a display condition for displaying the annotation condition via a determination using the viewpoint condition.

Also, the range of the viewpoint position in the virtual viewport information (AnViewport) will now be described as a supplement with reference to FIG. 27. A viewpoint 2701 of FIG. 27 represents a viewpoint in a three-dimensional space, and a reference point 2702 represents a reference point of the partial region. The range of the viewpoint position is a range indicated by the relative positional relationship from the coordinates of the reference point 2702. In FIG. 27, the positional relationship is represented as a range of the distance between two points, which is the length of a straight line connecting the viewpoint in the three-dimensional space and the reference point indicated by arrow 2703 (in a case where the distance between the two points satisfies a predetermined condition (for example, is equal to or less than a predetermined threshold), the annotation information is displayed). Also, the positional relationship may be represented by the distance between two points with each point of the viewpoint and the reference point being projected on the xy plane (the plane in which the z coordinate is zero) indicated by arrow line 2704. In the case of using the distance between two points (for example, displaying the annotation information in a case where the distance between two points satisfies a predetermined condition), the z coordinate value of 2501 of the AnExtCamRange structure of FIG. 25 is 0 and the value of z_range of 2502 is 0.

According to such a configuration, a three-dimensional image file storing metadata including a view direction as a viewpoint condition can be generated. Thus, a three-dimensional image file can be generated so that, for any three-dimensional region in three-dimensional data, the display mode of annotation information is different according to the viewpoint direction.

### Third Embodiment

In the third embodiment, processing for reproducing a three-dimensional image file generated by the information processing apparatus 100 according to the first or second embodiment will be described. In the present embodiment, the apparatus that reproduces the three-dimensional image file is the information processing apparatus 100. However, an external apparatus different from the information processing apparatus 100 may be used as the reproduction apparatus.

Here, in response to a viewpoint position (or view direction) being set by the user for reproduction of a three-dimensional image file, the information processing apparatus 100 generates an image with annotation information superimposed in accordance with the viewpoint position and outputs the image to a display apparatus. In the following description, a file including the three-dimensional data 200 described in the first embodiment is reproduced. However, similar processing can be executed in the case of reproducing a three-dimensional image file generated by the information processing apparatus 100 according to the second embodiment.

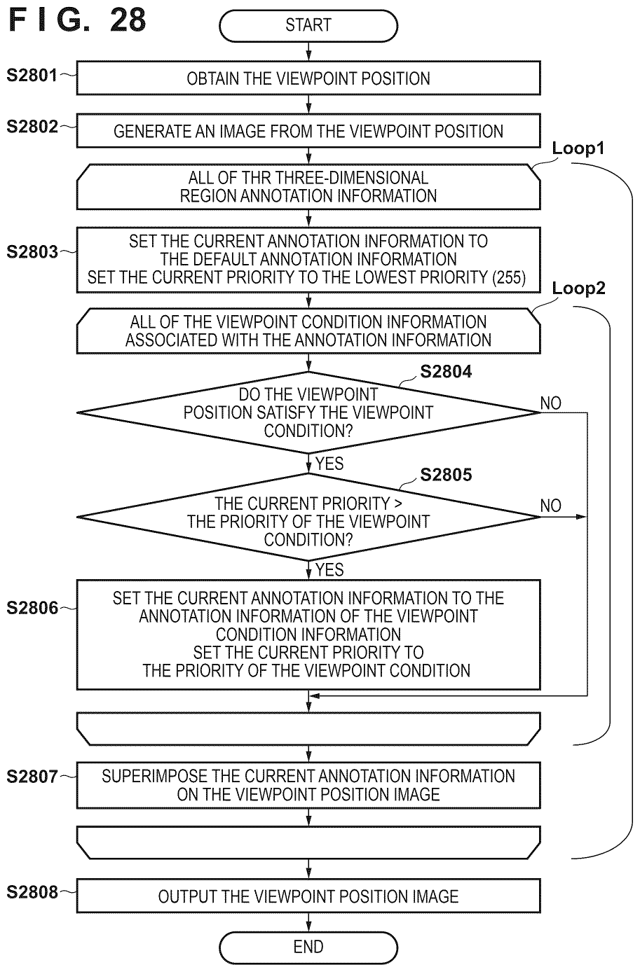

FIG. 28 is a flowchart illustrating an example of reproduction processing executed by the information processing apparatus 100 according to the present embodiment. The processing illustrated in FIG. 28 is implemented by the CPU 101 by reading a corresponding processing program stored in the ROM 102 and loading the program on the RAM 103 to cause the blocks to operate. Note that the reproduction processing illustrated in FIG. 28 described here is started when an operation input relating to an image file reproduction instruction is detected in a state where the information processing apparatus 100 is set to playback mode, for example.

In S2801, the information processing apparatus 100 obtains the viewpoint position for reproduction. Here, the information processing apparatus 100 can obtain the viewpoint position on the basis of a user input. Also, for example, the information processing apparatus 100 may be configured so that the viewpoint position is set from information indicating where a user is in pre-identified space.

In S2802, the information processing apparatus 100 generates an image from the viewpoint position using encoded data (the Volumetric Media 611) of the three-dimensional data 200 included in the file. Regarding the method of generating an image from three-dimensional data, typical three-dimensional image reproduction processing can be executed, and a detailed description thereof will be omitted.

Loop1 includes S2803 to S2807 and is loop processing for scanning all of the three-dimensional region annotation information included in the file. In the file 600, item ID=2 defined as “vran” corresponds to the three-dimensional region annotation information.

In S2803, the information processing apparatus 100 sets the current annotation information to the default annotation information. The default annotation information here is the annotation information provided to the three-dimensional region annotation information as a direct property. The default annotation information in the file 600 corresponds to “Object” defined as “udes” with property_index=3. Here, the current priority is set to the lowest priority (for example, 255 from 0 to 255). Loop2 includes S2804 to S2806, is nested loop processing within Loop1, and is a loop for scanning all of the viewpoint condition information associated with the three-dimensional region annotation information set as the current processing target. Here, all of the viewpoint condition information in the file 600 corresponds to item ID=3, item ID=4, and item ID=5 defined by “vvra” associated with item ID=2 (“vran”).

In S2804, the information processing apparatus 100 determines whether or not the viewpoint position satisfies the viewpoint condition set as the current processing target. The viewpoint condition described in the first embodiment may be used as the viewpoint condition. In a case where the viewpoint condition is not satisfied, the processing returns to the top of Loop2 and S2804 is started again with the next piece of viewpoint condition information as the processing target. In a case where the viewpoint condition is satisfied, the processing advances to S2805.

In S2805, the information processing apparatus 100 compares the current priority and the priority of the viewpoint condition set as the current processing target. In a case where value for the current priority is greater than that of the priority of the viewpoint condition set as the current processing target, the processing moves to S2806. Otherwise, the processing returns to the top of Loop2 and S2804 is started again with the next piece of viewpoint condition information as the processing target.

In S2806, the information processing apparatus 100 sets the annotation information of the viewpoint condition information set as the current processing target to the current annotation information. Also, the information processing apparatus 100 sets the priority of the viewpoint condition information set as the current processing target to the current priority. When scanning of all of the viewpoint condition information associated with the three-dimensional region annotation information set as the current processing target in Loop2 is complete, the processing advances to S2807.

In S2807, the information processing apparatus 100 superimposes the current annotation information on the viewpoint position image generated in S2802. When scanning of all of the three-dimensional region annotation information included in the file is complete in Loop1, the processing advances to S2808. In S2808, the information processing apparatus 100 outputs the viewpoint position image to the display apparatus and ends the processing of FIG. 28.

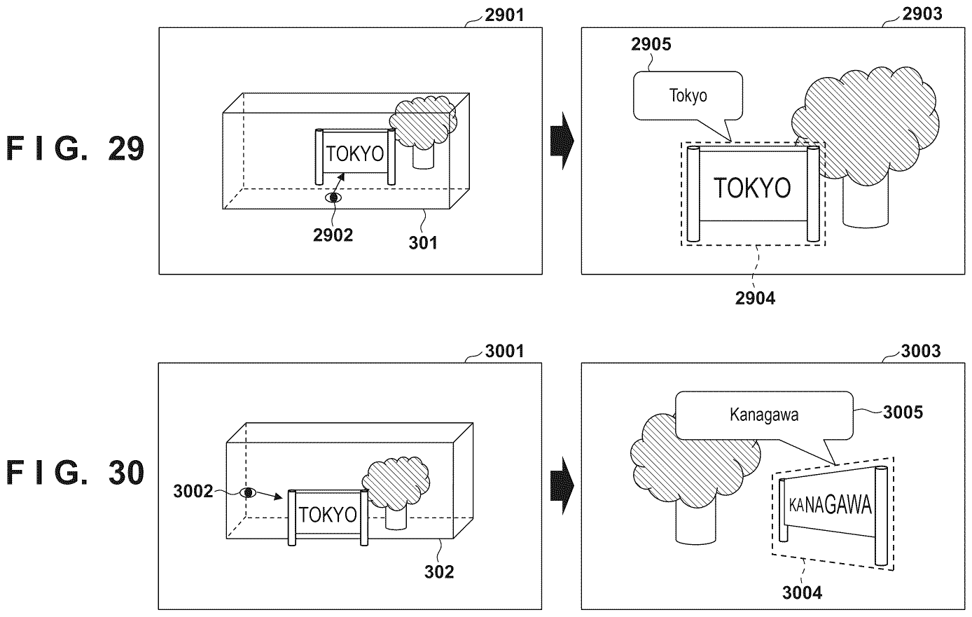

Next, an example of a viewpoint position designated by a user and the viewpoint position image output as a result will be described with reference to FIGS. 29 to 32.

FIG. 29 illustrates an example in a case where the user sets a viewpoint position 2902 inside the three-dimensional region 301 on a viewpoint position operation screen 2901. A file reproduction screen 2903 is output as an image with an object 2904 (“vran” corresponding to item ID=2) included in the viewpoint position image and annotation information 2905 of the object 2904 superimposed on the viewpoint position image of the viewpoint position 2902. Since the viewpoint position 2902 is set inside the three-dimensional region 301, as viewpoint conditions, item ID=3 (“Tokyo”) and item ID=5 (“Nameboard”) are true (satisfied). Of these, since the priority of item ID=3 is higher, the annotation information (“Tokyo”) of item ID=3 is output superimposed on the image.

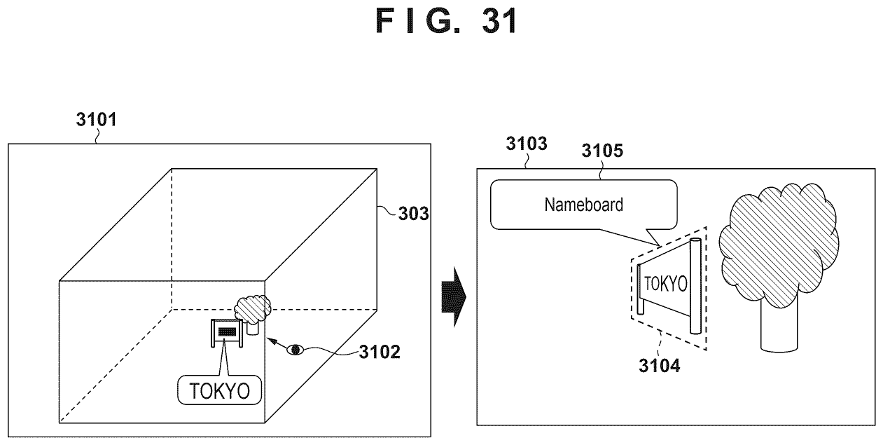

FIG. 30 illustrates an example in a case where the user sets a viewpoint position 3002 inside the three-dimensional region 302 on a viewpoint position operation screen 3001. A file reproduction screen 3003 is output as an image with an object 3004 (“vran” corresponding to item ID=2) included in the viewpoint position image and annotation information 3005 of the object 3004 superimposed on the viewpoint position image of the viewpoint position 3002. Since the viewpoint position 3002 is set inside the three-dimensional region 302, as viewpoint conditions, item ID=4 (“Kanagawa”) and item ID=5 (“Nameboard”) are true. Of these, since the priority of item ID=4 is higher, the annotation information (“Kanagawa”) of item ID=4 is output superimposed on the image.

FIG. 31 illustrates an example in a case where the user sets a viewpoint position 3102 inside the three-dimensional region 303 on a viewpoint position operation screen 3101. Note that the viewpoint position 3102 is not included in the three-dimensional region 301 and the three-dimensional region 302. A file reproduction screen 3103 is output as an image with an object 3104 (“vran” corresponding to item ID=2) included in the viewpoint position image and annotation information 3105 of the object 3104 superimposed on the viewpoint position image of the viewpoint position 3102. Here, the viewpoint position 3102 is set inside the three-dimensional region 303 and is not included in the three-dimensional region 301 and the three-dimensional region 302. Thus, as the viewpoint condition, only item ID=5 (“Nameboard”) is true. Accordingly, the annotation information (“Nameboard”) of item ID=5 is output superimposed on the image.

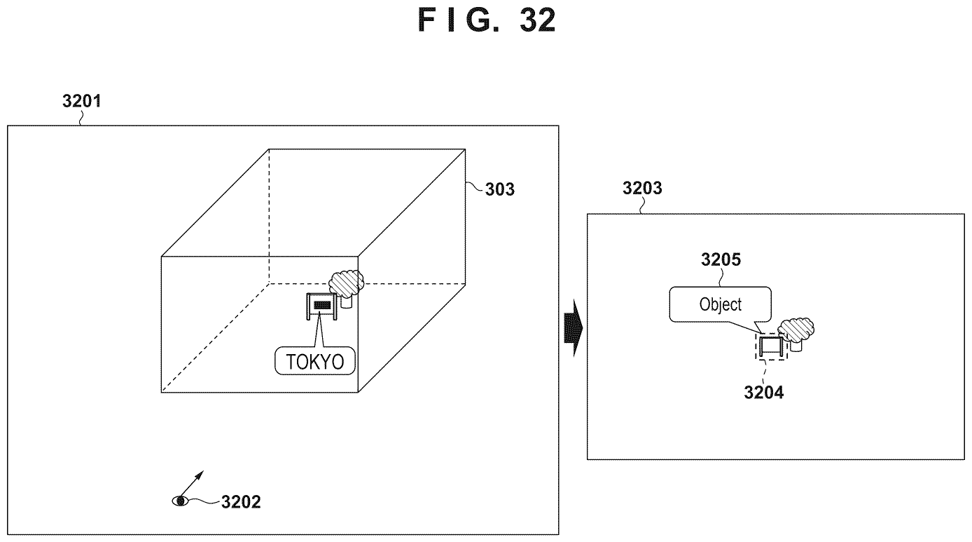

FIG. 32 illustrates an example in a case where the user sets a viewpoint position 3202 outside the three-dimensional region 303 on a viewpoint position operation screen 3201. A file reproduction screen 3203 is output as an image with an object 3204 (“vran” corresponding to item ID=2) included in the viewpoint position image and annotation information 3205 of the object 3204 superimposed on the viewpoint position image of the viewpoint position 3202. The viewpoint position 3202 is set outside the three-dimensional region 303, and an item with true as the viewpoint condition does not exist. Accordingly, the default annotation information (“Object”) of item ID=2 is output superimposed on the image.

According to such a configuration, reproduction can be performed of a three-dimensional image file storing encoded data of a three-dimensional image and metadata corresponding to the encoded data of the three-dimensional image including region information, annotation information, and condition information. In particular, appropriate annotation information to be displayed according to the viewpoint position can be set, and the annotation information can be output superimposed on the viewpoint position image.

### Fourth Embodiment

The information processing apparatus according to the first embodiment and the second embodiment obtains metadata including region information, the annotation information, and condition information and generates a three-dimensional image file including three-dimensional image data and the metadata. However, an information processing apparatus according to the fourth embodiment obtains encoded data of a three-dimensional image and metadata corresponding to the encoded data of the three-dimensional image including first region information relating to a first partial region in the three-dimensional image, second region information relating to a second partial region included in the first partial region, first annotation information associated with the first partial region, and second annotation information associated with the second partial region. Next, the information processing apparatus generates a three-dimensional image file storing the obtained three-dimensional image encoded data and the metadata.

The information processing apparatus 100 according to the present embodiment has basically the same configuration as that illustrated in FIG. 1 and similar processing can be executed. Thus, redundant descriptions will be omitted. Also, the configuration of the three-dimensional image file generated by the information processing apparatus 100 according to the present embodiment has basically that same configuration as that illustrated in FIG. 6A-6B of the first embodiment. Thus, only the differences between these will be described below.

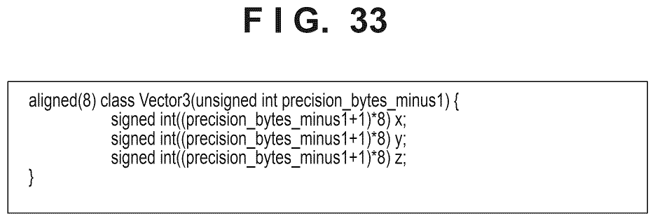

The item format of the three-dimensional region annotation information according to the present embodiment is similar to that illustrated in FIG. 7. The position information in the three-dimensional image according to the present embodiment is described by definition Vector 3 as illustrated in FIG. 33. The data structure of Vector3 includes x, y, and z coordinate information, and the bit size of the parameter is determined by precision information (precision) for the coordinate information for x, y, and z respectively.

The CuboidRegion data indicating the position and size of the partial region in a case where the shape of the partial region is a cuboid is similar to that illustrated in FIG. 20. Also, the QuaternionRotation data for indicating the rotation of the cuboid three-dimensional partial region using quaternion representation is similar to that illustrated in FIG. 22.

The information processing apparatus 100 according to the present embodiment describes, as metadata, information indicating the first annotation information associated with the first partial region in the three-dimensional image and the second annotation information associated with the second partial region included in the first partial region. A certain three-dimensional region item and a three-dimensional region item indicating the three-dimensional region inside of that (in other words, included in such a three-dimensional region) are associated, and thus the information of the inclusion relationship is stored in “iref” box. The reference type indicating the inclusion relationship of the partial regions (one partial region is included in the other partial region) is indicated by “svrg” described below in detail. Note that the three-dimensional region item included in the other region may be able to be identified using a different 4CC (for example, “vvra” or the like) instead of the item type “vran”. In a case where the three-dimensional region included in the other three-dimensional region is associated with a different three-dimensional image item and a different 4CC is used for identifying, a region item with vran as the item type needs to be separately designated. In other words, regardless of whether or not the three-dimensional region item is a region included in another region, by defining it as “vran”, various associations are possible. Note that it is sufficient that the value designated in 4CC is a predefined value, and it is desirable that a value different from the 4CC used for other applications is used. As another method, to indicate the three-dimensional region included in another region, this can be identified using a flag value of VolumetricRegionItem illustrated in FIG. 4. In this manner, by associating and storing the three-dimensional region included in another three-dimensional region, instead of all of the annotation information associated with the three-dimensional region at the time the image file is reproduced being the target of selection or display, the information can be selectively switched and indicated as usable data. This may be, for example, a method including switching using the viewpoint information and the line-of-sight information at the time of reproduction.

The information processing apparatus 100 may be configured so that the target range can be identified in advance in the item property or other data structure regarding the viewpoint position and the view direction. Such metadata, for example, can be stored as metadata with, in a case where the spatial position of a viewpoint designated by a reproduction apparatus at the time of reproduction is included in a three-dimensional region indicating a three-dimensional region item included in (inside of) another three-dimensional region, the annotation information associated with the inside three-dimensional region item intended as the selection (or display) target. The information processing apparatus 100 stores the metadata with the annotation information associated with a wide range region including the region not intended as a selection (display) target. On the other hand, in a case where the spatial position of a viewpoint designated by a reproduction apparatus at the time of reproduction is not included in a three-dimensional region indicating a three-dimensional region item inside, the metadata can be stored with the annotation information associated with the inside three-dimensional region item not intended as the selection (or display) target. The information processing apparatus 100 stores the metadata with the annotation information associated with a wide range region including the region intended as a selection (display) target. In other words, the information processing apparatus 100 according to the present embodiment may select the annotation information associated with the region information of the lowest level (spatially narrowest range) indicating the place where the viewpoint position is as a selection (or display) target.

In a case where the view direction is taken into account in addition to the viewpoint position, the information processing apparatus 100 may store the annotation information associated with an image from the place where the viewpoint position is as metadata intended for selection (or display). The information processing apparatus 100 selects (or displays) annotation information associated with a three-dimensional region item associated with a three-dimensional image in the view direction from the region of the highest level (spatially widest region) including the spatial position of the viewpoint designated by the reproduction apparatus. In this case, in a case where the three-dimensional partial region information is not associated with the spatial position of the three-dimensional image indicated by the viewpoint position, annotation directly associated with the three-dimensional image is selected, and in a case where the spatial position is included in any three-dimensional region, the annotation information associated with the inside of the three-dimensional space or associated with the three-dimensional space itself is selected as the selection (or display) target. On the other hand, annotation information associated with another region is not a selection (or display) target. In a case where the view direction is also taken into account, whether or not to set an internal region in the view direction from the viewpoint position as the selection target (target for displaying the associated annotation information) can be identified by whether or not a region in the three-dimensional image indicating a three-dimensional region of a certain size or greater is the display target. In a case where an internal region does not exist as the target, selection can be performed in a similar manner as when only the viewpoint position is taken into account.

In another possible configuration, a certain partial region is indicated as a region included in another partial region and indicated as the default selection target (target for display of the associated annotation information). In this configuration, for example, the relationship may be identified using a flag value of VolumetricRegionItem. The default selection (or display) target may be indicated using item property or the like. Also, another configuration may be used in which, when selecting a region, data is used that sets the annotation information as the selection (or display) target only in a case where a region equal to or greater than a threshold is the display target. This can be designated in a similar manner using an item property or the like. A three-dimensional region designated in a region which is the default selection (or display) target may be set as the selection (or display) target irrespective of the viewpoint and line-of-sight as described above and may be set as the selection (or display) target in a case where the region is included inside the three-dimensional image to be displayed or included to a certain extent or greater.

The information processing apparatus 100 according to the present embodiment can, in a case where either one of the first annotation information to be displayed in association with the first partial region and the second annotation information to be displayed in association with the second partial region included in the first partial region satisfies the viewpoint condition and can be displayed, include in the metadata information indicating the display priority of which one of the pieces of annotation information to preferentially display. The setting of the display priority can be performed in a similar manner to the setting of priority for the viewpoint condition in the first embodiment. Here, for example, the information processing apparatus 100 may be configured so that the annotation information associated with the largest partial region (in this example the first partial region as first partial region>second partial region), from among the regions that satisfy the viewpoint condition, is displayed. Also, which annotation information, from among the pieces of annotation information that can be displayed, to display may be determined in response to a user selection.

Also, the information processing apparatus 100 can set a first viewpoint condition for the first annotation information and a second viewpoint condition for the second annotation information and include these in the metadata. The viewpoint condition used here can be the same as that in the first and second embodiment. For example, the information processing apparatus 100 may generate a viewport in a similar manner to the second embodiment on the basis of the viewpoint position and the view direction and, in a case where a straight line from the viewpoint position to the reference point of each partial region passes through the viewport, may display the annotation information associated with the partial region. Also, for example, in a case where the angle formed by the straight line direction from the viewpoint position to the reference point of the partial region and the view direction is equal to or less than a predetermined threshold (for example) 30°, the information processing apparatus 100 may display the annotation information associated with the partial region. Also, configuration may be such that in a case where the viewpoint position is included in the first partial region and is outside the second partial region, the information processing apparatus 100 displays the second annotation information if the second viewpoint condition is satisfied and does not display the second annotation information if the second viewpoint condition is not satisfied. Also, in a case where a plurality of pieces of annotation information exist, the information processing apparatus 100 may set one or more of these as the annotation information to always be displayed.

For example, at the time of reproduction of the three-dimensional image file, in a case where the viewpoint position exists inside the second partial region, the information processing apparatus 100 may display the second annotation information and may not display the first annotation information. Also, for example, at the time of reproduction of the three-dimensional image file, in a case where the viewpoint position does not exist inside the second partial region, the information processing apparatus 100 may display the first annotation information and may not display the second annotation information.

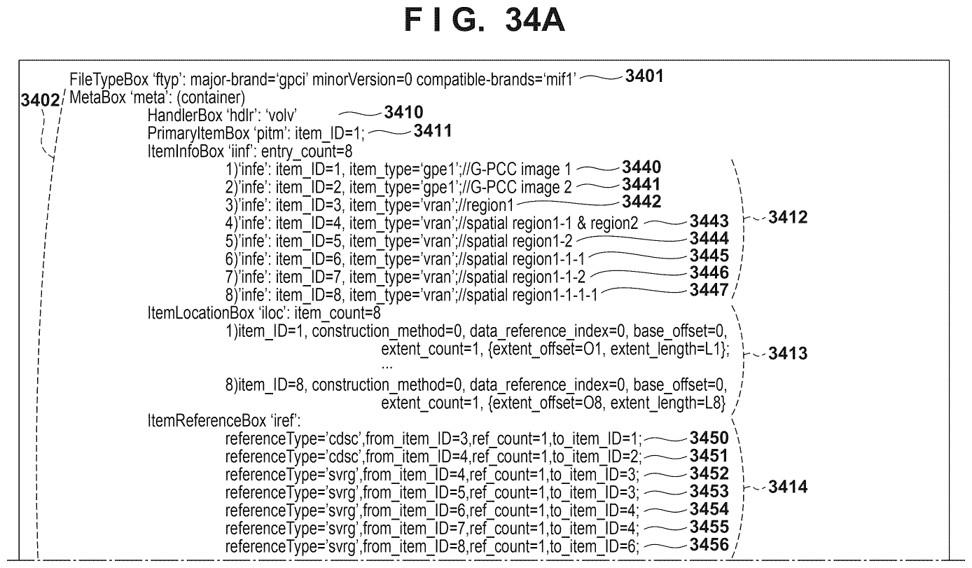

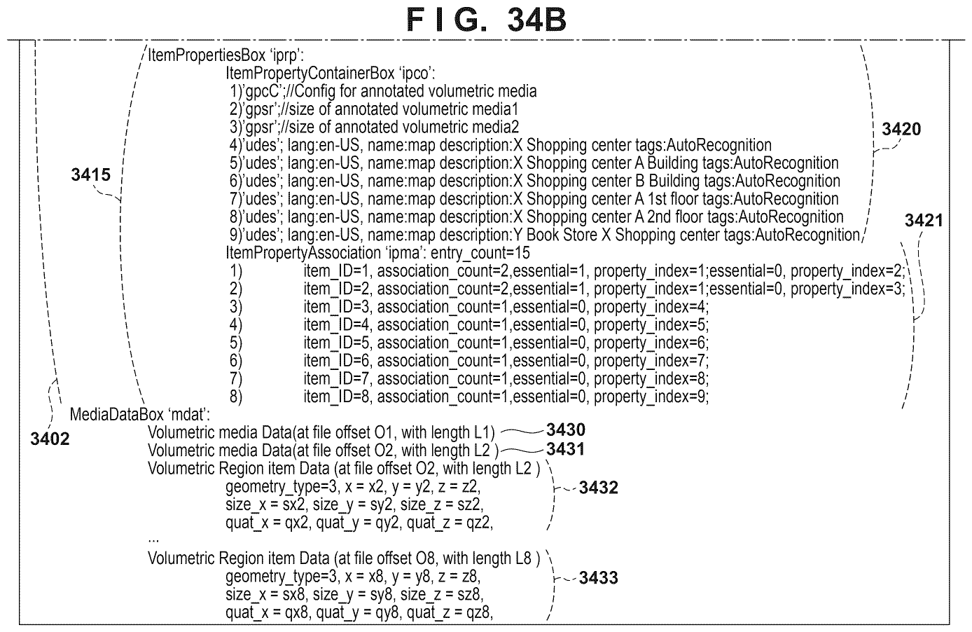

Next, an example of the configuration of the file generated by the information processing apparatus 100 according to the present embodiment and the structure of the metadata of such a file will be described with reference to FIGS. 34 to 36. Note that in the example of the present embodiment described below, an image file storing two three-dimensional images and six three-dimensional regions in the file data structure is generated.

FIG. 34A-34B are diagrams illustrating an example of the configuration of the file generated by the information processing apparatus 100 according to the present embodiment. In the example of FIG. 34B, as indicated in description 3403 corresponding to “mdat” box, description 3430 and description 3431 corresponding to the volumetric media encoded data (Volumetric Media Data) are stored. Also, in the example of FIG. 34B, descriptions 3432 and 3433 corresponding to three-dimensional region annotation information data (VolumetricRegionItemData) are stored in the image file. As indicated in the description 3432 and the description 3433, the three-dimensional region information data used here is compliant with the definition illustrated in FIG. 7 and both specify a cuboid region. The region specified in the description 3432 designates the coordinates (x2, y2, z2) of the reference point of the partial region in the coordinate space, the shape size (sx2, sy2, sz2), and the quaternion representation components (qx2, qy2, qz2). In a similar manner, the region specified in the description 3433 designates the coordinates (x8, y8, z8) of the reference point in the region reference space, the shape size (sx8, sy8, sz8), and the quaternion representation components (qx8, qy8, qz8).

Description 3401 corresponds to a “ftyp” box, and in the example of FIG. 34A, “gpc1” is described as a brand name (as major-brand) and “mif1” is described as a compatible brand name (as compatible-brands).

Next, in description 3402 corresponding to the “meta” box, various types of information of metadata describing untimed data stored in an output file example are indicated.

Description 3410 corresponds to a “hdlr” box, and the handler type of the MetaDataBox (meta) designated is “volv”. Description 3411 corresponds to a “pitm” box, and 1 is stored as item_ID and an ID of an image to be displayed is designated as a first priority image.

Description 3412 corresponds to an “iinf” box, and each item indicates item information (item ID (item_ID) or item type (item_type)). The description 3412 can identify each item by item ID and indicates what kind of item the item identified by item ID is. In the example of FIG. 34A, entry_count is 8 as eight items are stored. In the description 3412, eight types of information are listed, each designating the item ID and the item type. In the illustrated image file, the first and second pieces of information corresponding to description 3440 and description 3441 are G-PCC encoded image items of type “gpe1”. Also, the third to eighth pieces of information corresponding to description 3442 to description 3447 are three-dimensional region items of item type “vran” indicating a three-dimensional region.

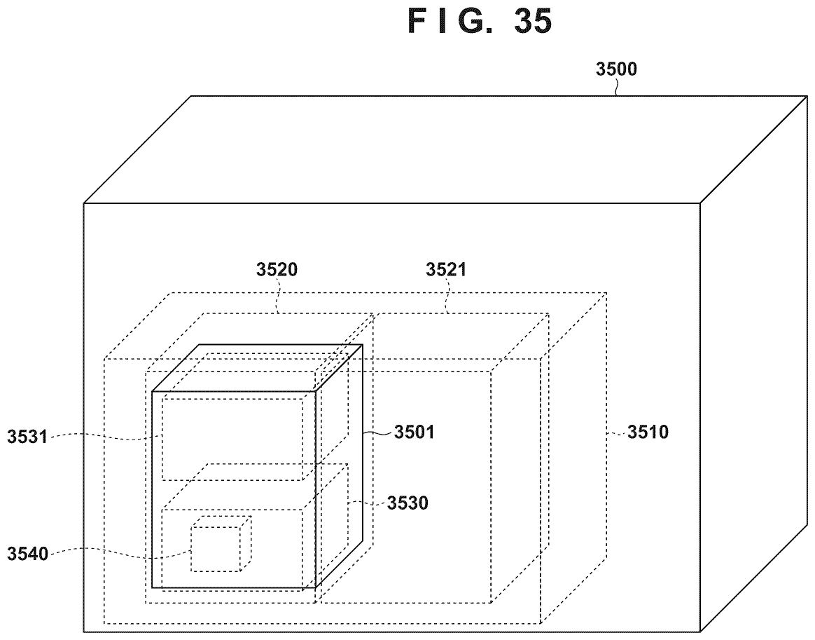

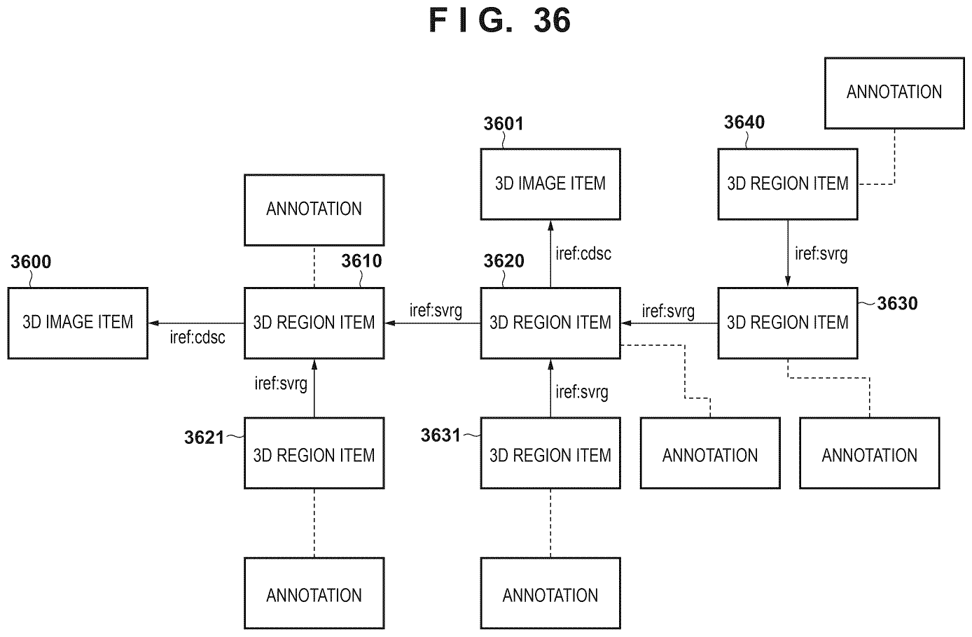

Here, the corresponding relationship of each item in FIGS. 34, 35, and 36 will be described. Note that FIG. 36 is a schematic view of the three-dimensional image items and three-dimensional region items indicated in the output file of FIGS. 34A-34B and the metadata structure relating to the associated annotation information. Also, FIG. 35 illustrates an example of the three-dimensional image data corresponding to such an image file.

The three-dimensional image corresponding to the G-PCC encoded image item of the description 3440 of FIG. 34A corresponds to a cuboid 3500 indicated by a solid line in FIG. 35 and a three-dimensional image item 3600 in FIG. 36. Also, the three-dimensional image corresponding to the G-PCC encoded image item of the description 3441 corresponds to a cuboid 3501 indicated by a solid line in FIG. 35 and a three-dimensional image item 3601 in FIG. 36. Next, the three-dimensional partial region corresponding to the three-dimensional region item of description 3442 of FIG. 34A corresponds to a cuboid 3510 indicated by a dashed line in FIG. 35 and a three-dimensional region item 3610 in FIG. 36. In a similar manner, the three-dimensional partial region corresponding to the three-dimensional region item of description 3443 of FIG. 34A corresponds to a cuboid 3520 indicated by a dashed line in FIG. 35 and a three-dimensional region item 3620 in FIG. 36. The three-dimensional partial region corresponding to the three-dimensional region item of description 3444 of FIG. 34A corresponds to a cuboid 3521 indicated by a dashed line in FIG. 35 and a three-dimensional region item 3621 in FIG. 36. The three-dimensional partial region corresponding to the three-dimensional region item of description 3445 of FIG. 34A corresponds to a cuboid 3530 indicated by a dashed line in FIG. 35 and a three-dimensional region item 3630 in FIG. 36. The three-dimensional partial region corresponding to the three-dimensional region item of description 3446 of FIG. 34A corresponds to a cuboid 1131 indicated by a dashed line in FIG. 35 and a three-dimensional region item 3631 in FIG. 36. The three-dimensional partial region corresponding to the three-dimensional region item of description 3447 of FIG. 34A corresponds to a cuboid 3540 indicated by a dashed line in FIG. 35 and a three-dimensional region item 3640 in FIG. 36.

As described above, the three-dimensional region item indicated in the description 3443 is a partial region included in the three-dimensional region item indicated in the description 3442 and is also a three-dimensional region item directly associated with the three-dimensional image item indicated in the description 3441. In a case where a three-dimensional image obtained from outside a building and a three-dimensional image obtained from inside the building are each stored separately in a file, for example, the effect of being able to switch between and use the image of outside the building and the image of inside the building and the like can be achieved.

Description 3413 corresponds to a “iloc” box and describes information including the storage location in the image file and the data size of each item. For example, the G-PCC encoded image item of item ID=1 is stored in a place with an offset of 01 in the file, and the size indicates LI bytes. In this manner, by referencing the description 3413, the location of the data in the “mdat” box can be identified.

Description 3414 corresponds to an “iref” box and indicates the reference relationship (association) between each item. As the association between each item indicated in description 3450 and description 3451, “cdsc” indicating the content description relationship is designated in the reference type. The description 3450 indicates that the G-PCC image item with an item ID of 1 designated in to_item_ID is referenced from the region information item with an item ID of 3 designated in from_item_ID. Accordingly, the three-dimensional region information item with an item ID of 3 indicates a partial region in the G-PCC image item with an item ID of 1. This corresponds to an arrow (iref: cdsc) from the three-dimensional region item 3610 to the three-dimensional image item 3600 in FIG. 36. In a similar manner, the description 3451 indicates that the G-PCC image item with an item ID of 2 designated in to_item_ID is referenced from the three-dimensional region information item with an item ID of 4 designated in from_item_ID. Accordingly, the three-dimensional region information item with an item ID of 4 indicates a partial region in the G-PCC image item with an item ID of 2. This corresponds to an arrow (iref: cdsc) from the three-dimensional region item 3620 to the three-dimensional image item 3601 in FIG. 36.

The association between the items indicated in description 3452, description 3453, description 3454, description 3455, and description 3456 is designated as “svrg”, which indicates, in the reference type, that it is an inclusion relationship of partial regions (one partial region is included in another partial region). The description 3452 indicates that the region information item with an item ID of 3 designated in to_item_ID is referenced from the region information item with an item ID of 4 designated in from_item_ID. Accordingly, this indicates that the partial region indicated by the three-dimensional region information item with an item ID of 4 is the partial region included in the partial region indicated by the region information item with an item ID of 3. This corresponds to an arrow (iref: svrg) from the three-dimensional region item 3620 to the three-dimensional region item 3610 in FIG. 36.

The description 3453 indicates that the region information item with an item ID of 3 designated in to_item_ID is referenced from the region information item with an item ID of 5 designated in from_item_ID. Accordingly, this indicates that the partial region indicated by the three-dimensional region information item with an item ID of 5 is the partial region included in the partial region indicated by the region information item with an item ID of 3. This corresponds to an arrow (iref: svrg) from the three-dimensional region item 3621 to the three-dimensional region item 3610 in FIG. 36.

The description 3454 indicates that the region information item with an item ID of 4 designated in to_item_ID is referenced from the region information item with an item ID of 6 designated in from_item_ID. Accordingly, this indicates that the partial region indicated by the three-dimensional region information item with an item ID of 6 is the partial region included in the partial region indicated by the region information item with an item ID of 4. This corresponds to an arrow (iref: svrg) from the three-dimensional region item 3630 to the three-dimensional region item 3620 in FIG. 36.

The description 3455 indicates that the region information item with an item ID of 4 designated in to_item_ID is referenced from the region information item with an item ID of 7 designated in from_item_ID. Accordingly, this indicates that the partial region indicated by the three-dimensional region information item with an item ID of 7 is the partial region included in the partial region indicated by the region information item with an item ID of 4. This corresponds to an arrow (iref: svrg) from the three-dimensional region item 3630 to the three-dimensional region item 3620 in FIG. 36.

The description 3456 indicates that the region information item with an item ID of 6 designated in to_item_ID is referenced from the region information item with an item ID of 8 designated in from_item_ID. Accordingly, this indicates that the partial region indicated by the three-dimensional region information item with an item ID of 8 is the partial region included in the partial region indicated by the region information item with an item ID of 6. This corresponds to an arrow (iref: svrg) from the three-dimensional region item 3640 to the three-dimensional region item 3630 in FIG. 36.

In this manner, by associating together the three-dimensional region information items, a certain partial region being a region included in another partial region can be indicated in terms of the association between three-dimensional region items given a pseudo-hierarchical structure (a structure associating a spatially narrow range based on a spatially wider range). Accordingly, an image file can be generated that includes metadata that, for a three-dimensional partial region in a three-dimensional image space, can indicate a partial region indicating (a narrower space) inside the three-dimensional partial region and can selectively switch between the associated annotation information.

Description 3415 corresponds to an “iprp” box and includes description 3420 corresponding to an “ipco” box and description 3421 corresponding to an “ipma” box. The description 3420 lists, as entry data, the property information that can be used in each item or entity group. As illustrated, the description 3420 includes a first entry indicating a G-PCC encoded parameter, and a second and third entry indicating the size of the three-dimensional space region in the Cartesian coordinates along the x, y, z axes of the three-dimensional image item. In addition, the description 3420 includes the fourth to ninth entry indicating the annotation information. Here, the annotation information uses American English (en-US) for the language for all of the entries, and the name of all of the entries is described as “map”. Also, as the description, in the fourth to ninth entries in order, “X Shopping center”, “X Shopping center A Building”, “X Shopping center B Building”, “X Shopping center A 1st floor”, “X Shopping center A 2nd floor”, and “Y Book Store X Shopping center” are described indicating the names of the map position indicated by the regions. Here, a tag is provided indicating that the region has been automatically recognized, and thus “AutoRecognition” is described in tags.

The attribute information listed in the description 3420 is associated with each item stored in the image file in the entry data of the description 3421 corresponding to the “ipma” box. In the example of FIG. 34B, a common “gpcC” (property_index of 1) is associated with the three-dimensional image items with an item ID of 1 and 2, indicating that it is the same G-PCC encoded parameter. “gpsr” (property_index of 2) is associated with the three-dimensional image item with an item ID of 1, and “gpsr” (property_index of 3) is associated with the three-dimensional image item with an item ID of 1, with each designated the size of the three-dimensional space region. “udes” (property_index of 4) is associated with the three-dimensional region information item with an item ID of 3, with annotation information associated with the partial region being indicated. “udes” (property_index of 5) is associated with the three-dimensional region information item with an item ID of 4, with annotation information associated with the partial region being indicated. “udes” (property_index of 6) is associated with the three-dimensional region information item with an item ID of 5, with annotation information associated with the partial region being indicated. “udes” (property_index of 7) is associated with the three-dimensional region information item with an item ID of 6, with annotation information associated with the partial region being indicated. “udes” (property_index of 8) is associated with the three-dimensional region information item with an item ID of 7, with annotation information associated with the partial region being indicated. “udes” (property_index of 9) is associated with the three-dimensional region information item with an item ID of 8, with annotation information associated with the partial region being indicated. These correspond to each three-dimensional region item in FIG. 36 and the annotation information with the association indicated by dashed lines.

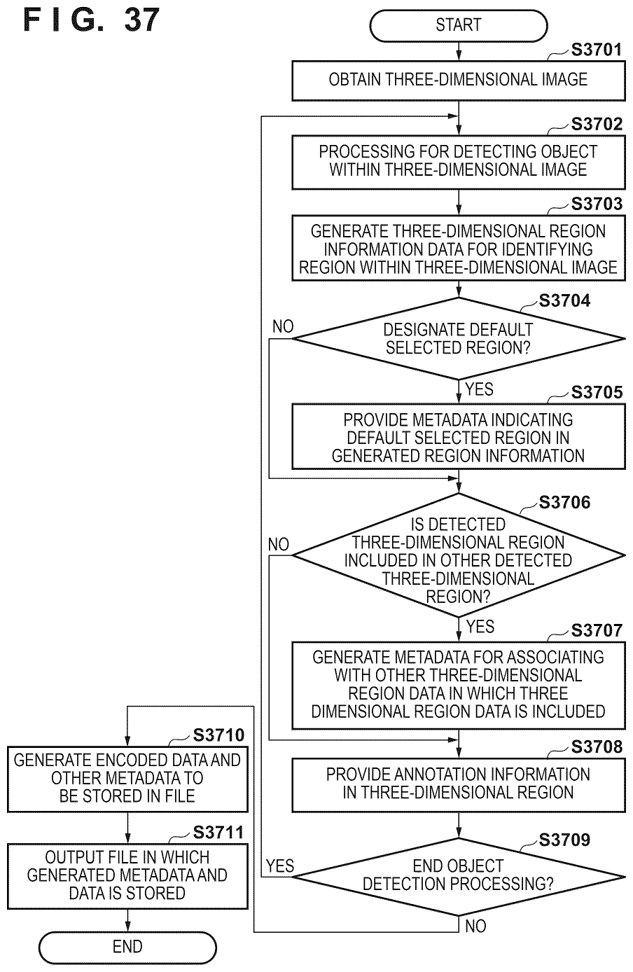

The generation processing of the three-dimensional image file by the information processing apparatus 100 according to the present embodiment will be described below. FIG. 37 is a flowchart illustrating an example of three-dimensional image file generation processing executed by the information processing apparatus 100 according to the present embodiment. The processing corresponding to the flowchart is implemented by the CPU 101 by reading a program stored in the ROM 102 and loading the program on the RAM 103 to cause the blocks to operate. Note that the processing illustrated in FIG. 37 may, for example, be executed in response to the user inputting an operation start operation or may be started in response to image capture being performed.

In S3701, the CPU 101 controls the imaging unit 104 or the image processing unit 105 and obtains three-dimensional image data to be stored in a file. In S3702, the recognition processing unit 114 executes processing for detecting an object in the three-dimensional image. In S3703, the generation unit 113 generates region information relating to the partial region indicating the object detected by the recognition processing unit 114 in the three-dimensional image. S3701 to S3703 are similar to the processing of S401 to S403 in the first embodiment and thus will not be described in detail.

In S3704, the CPU 101 determines whether to default select (reproduce) the annotation information relating to the region information data generated in S3703. In the case of default reproduction, the processing advances to S3705. Otherwise, the processing advances to S3706.

In S3705, the metadata processing unit 112 adds information indicating the default selected region to the generated region information data. S3705 can be executed by setting a specific bit (to 1) in flags of VolumetricRegionItem illustrated in FIG. 4, for example. In addition, various other predefined methods that may be used to execute S3705 include a method of associating a property with a region information item as item property information.

In S3706, the CPU 101 determines whether the three-dimensional region detected in S3702 is a region included in the other detected three-dimensional region. S3702 includes identifying whether the processing target region is spatially included in the other region. Here, it is determined whether or not one region is included in another region and whether it is a region indicating the inside structure. Note that in this example, after a three-dimensional region on the outside (a region with a possibility of containing another region) is first identified, in order, whether or not a three-dimensional region inside this three-dimensional region is included in another three-dimensional region is determined. However, it is sufficient that whether a three-dimensional region is included in (or includes) another three-dimensional region can be determined in a similar manner, and the processing is not in particular limited. In a case where it is determined that the three-dimensional region detected in S3702 is a region included in another detected three-dimensional region, the processing advances to S3707. Otherwise, the processing advances to S3708.

In S3707, the metadata processing unit 112 generates metadata for associating a processing target three-dimensional region with data of another three-dimensional region including the three-dimensional region. S3703 is executed by performing association using the item reference type “svrg” illustrated in FIG. 34A.

In S3708, the metadata processing unit 112 associates the annotation information with the processing target three-dimensional region. Here, text description information is associated with the three-dimensional region using an item property.

In S3709, the CPU 101 determines whether or not to perform detection for another object (three-dimensional partial region). In the case of executing detection processing, the processing returns to S3702. In the case of ending the detection processing, the processing advances to S3710.

In S3710, the encoding/decoding unit 111 executes encoding processing on the three-dimensional image data and stores the encoded data in the output buffer. Also, the metadata processing unit 112 merges the metadata generated in the processing up to S3709 and the metadata required to decode the encoded data, generates “meta” box structure data, and stores this in the output buffer. In S3711, the metadata processing unit 112 combines “ftyp” box information relating to the three-dimensional image file, “meta” box information storing the final metadata, and “mdat” box information storing items such as the encoded data and viewpoint condition information. Then, the CPU 101 writes the generated image file storing the combined metadata and image data from the RAM 103 to the non-volatile memory 110, stores the file, and ends the processing illustrated in FIG. 37. S3710 to S3711 are similar to the processing of S410 to S411 and thus will not be described in detail.

According to such a configuration, a three-dimensional image file can be generated storing metadata corresponding to a three-dimensional image including first region information relating to a first partial region in the three-dimensional image, second region information relating to a second partial region included in the first partial region, first annotation information associated with the first partial region, and second annotation information associated with the second partial region. In particular, by storing metadata indicating an inclusion relationship between partial regions giving the three-dimensional regions a pseudo-hierarchical structure (a structure associating a spatially narrower range based on a spatially wider range), an image file that can be used by selectively switching between annotation information displayed at the time of reproduction processing or the like can be generated.

Note that in the present embodiment, the image data stored in the image file is obtained by image capture by the imaging unit 104, but the image data used here is not limited in this manner. For example, a sequence of image data may be pre-stored in the ROM 102 or the non-volatile memory 110 or may be received via the communication unit 108. In this case, the three-dimensional image data may include an image file storing one three-dimensional still image. Also, the image data may be image data encoded in the image file storing a plurality of pieces of three-dimensional still image data or may be unencoded RAW image data.

Also, in the present embodiment described above, a still image is used as a three-dimensional image. However, no such limitation is intended. For example, the three-dimensional image may be defined as three-dimensional region information data using a three-dimensional video or three-dimensional image sequence as the three-dimensional image. Also, in a similar manner, a partial region included in a partial region in accordance with the type can be designated in a similar manner using a metadata structure for storing the three-dimensional video. Specifically, metadata is described relating to a three-dimensional video or image sequence using a moov box in a metadata structure specified in ISOBMFF. A time-designated sequence of media data belonging to a presentation of three-dimensional video data is displayed in a trak box designating in a moov box. For example, a sequence of volumetric media frames, a sequence of subparts of volumetric media frames, or a sequence of time-designated metadata samples are described as a time-designated sequence of media data. In each track, each time unit of data is referred to as a sample. This sample may be a frame of volumetric media, video, audio, or time-designed metadata, a subpart of a frame, or an image in an image sequence. Here, sample is defined as all of the media data associated with presentation time on the same track.

In this case, the three-dimensional region information data is stored in an “mdat” box storing three-dimensional volumetric encoded data. Also, the metadata of a time-based sequence describing three-dimensional region information data is configured as a track storing a time-based sequence referred to as a metadata track. By associating the metadata track to a three-dimensional video track using a tref box, a three-dimensional region in a three-dimensional video can be indicated. A three-dimensional region relating to a plurality of objects is designated in one three-dimensional region metadata track, and each three-dimensional region can be identified via an ID or the like in the region information data stored in a “mdat” box. The inclusion relationship of the three-dimensional regions and annotation information can be provided by grouping the samples using a sample group structure and using a sample group description box.

According to such processing, three-dimensional region information can be separately identified in not only three-dimensional still images but also three-dimensional video data, and the spatial inclusion relationship of these regions can be identified. Note that as long as a similar processing can be executed, an extension using a metadata structure suited for other video may be performed.

### Fifth Embodiment

In the fifth embodiment, processing for reproducing a three-dimensional image file generated by the information processing apparatus 100 according to the fourth embodiment will be described. In the present embodiment, the apparatus that reproduces the three-dimensional image file is the information processing apparatus 100. However, an external apparatus different from the information processing apparatus 100 may be used as the reproduction apparatus.

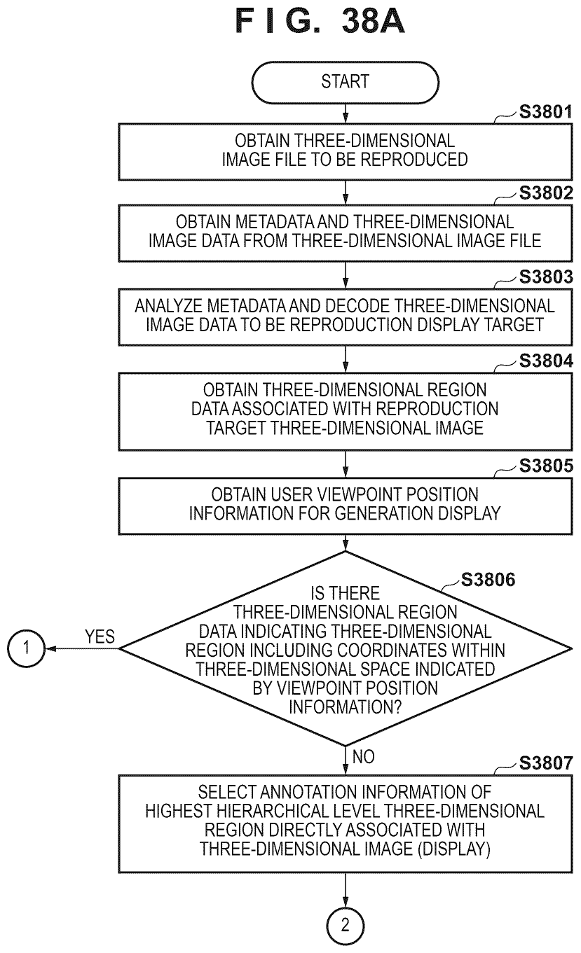

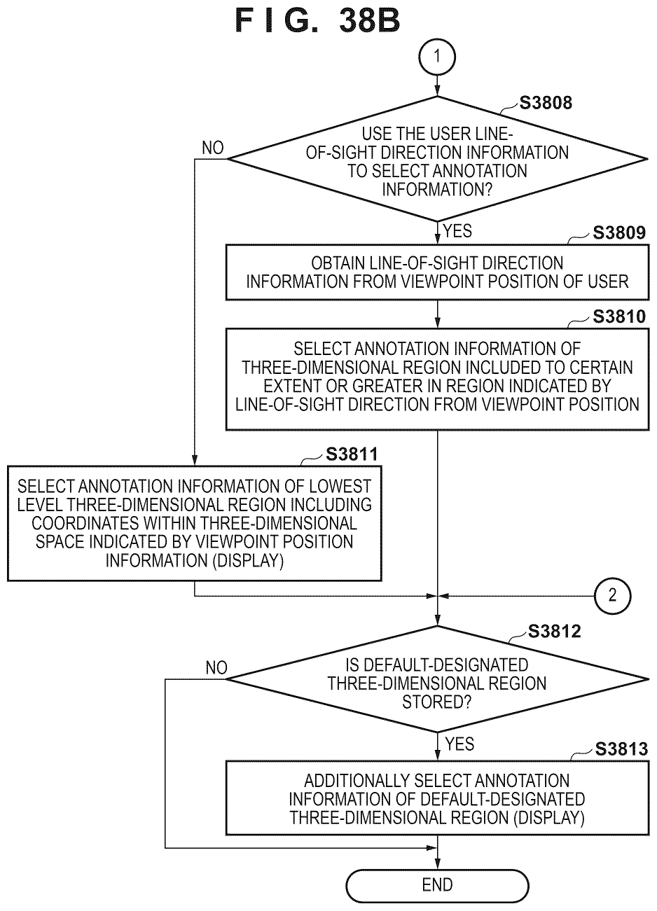

FIG. 38A-38B are flowcharts illustrating an example of reproduction processing executed by the information processing apparatus 100 according to the present embodiment. The processing illustrated in FIG. 38A-38B is implemented by the CPU 101 by reading a corresponding processing program stored in the ROM 102 and loading the program on the RAM 103 to cause the blocks to operate. Note that the reproduction processing illustrated in FIG. 38A-38B described here is started when an operation input relating to an image file reproduction instruction is detected in a state where the information processing apparatus 100 is set to playback mode, for example.

In S3801, the CPU 101 obtains an image file (target file) which was targeted for reproduction by a reproduction instruction. In S3802, the CPU 101 obtains metadata and image data from the image file, and the target file configuration is comprehended by the metadata processing unit 112 analyzing the obtained metadata.

In S3803, the CPU 101 identifies a representative item on the basis of the information of the “pitm” box of the metadata and causes the encoding/decoding unit 111 to decode encoded data 241 indicating the representative item. Next, the encoding/decoding unit 111 obtains the encoded data corresponding to the metadata relating to the image item designated as the representative image, executes decoding processing, and stores the data obtained via the decoding processing in a buffer on the RAM 103.

In S3804, the metadata processing unit 112 obtains three-dimensional region data associated with the reproduction target image designated as the representative image. In S3805, the metadata processing unit 112 obtains information of the user viewpoint position for displaying the three-dimensional image when reproducing and displaying. Here, the metadata processing unit 112 can obtain the viewpoint position on the basis of a user input. Also, for example, the metadata processing unit 112 may be configured so that the viewpoint position is set from information indicating where a user is in pre-identified space.

In S3806, the metadata processing unit 112 determines whether or not there is three-dimensional region data indicating a three-dimensional region including coordinates inside a three-dimensional space indicated by the obtained viewpoint position information. In a case where such data is not included, the processing advances to S3807. In a case where such data is included, the processing advances to S3808.

In S3807, the metadata processing unit 112 selects (displays) the annotation information of the three-dimensional region of the highest hierarchical level (spatially widest range) associated with the three-dimensional image. Here, the metadata processing unit 112 displays the representative image data stored in the buffer and outputs and displays the associated region data together with the representative image data on the display unit 106. In a case where region annotation information corresponding to the partial region is provided, the association with the partial region is displayed in an identifiable manner. In a case where S3807 ends, the processing advances to S3812.

In S3808, the metadata processing unit 112 determines whether or not to use the view direction information in selecting the annotation information (region information data). Whether or not to use the view direction information is designated in advance in the settings of the information processing apparatus 100 or the like in this example. In the case of not using the view direction information, the processing advances to S3811. In the case of using the view direction information, the processing advances to S3809.

In S3811, the metadata processing unit 112 selects (displays) the annotation of the three-dimensional region of the lowest level (spatially narrowest range) including coordinates inside the three-dimensional space indicated by the viewpoint position information. Here, for example, annotation associated with the place in the space where the designated position is selected (displayed). Next, as in S3807, region information and annotation information associated with the region information is superimposed and displayed together with the representative image data stored in the buffer. In a case where S3811 ends, the processing advances to S3812.

In S3809, the metadata processing unit 112 obtains view direction information from the user viewpoint position. As in S3805, the processing for obtaining the view direction information from the user viewpoint position may be executed on the basis of a user input or may be executed by using a head-mounted display or the like to detect the direction that the user is facing in a pre-identified space.

In S3810, the metadata processing unit 112 selects (displays) the annotation information of the region indicated by the three-dimensional region information included to a certain extent or greater in the display region included in the view direction from the viewpoint position. Next, as described above, the annotation information and the three-dimensional image data are superimposed and displayed. In a case where there is no region included to a certain extent or greater, as in S3811, the annotation information of the region indicated by the viewpoint position is selected (displayed). In a case where S3811 ends, the processing advances to S3812.

In S3812, the metadata processing unit 112 determines whether the default-designated three-dimensional region is stored (exists). In a case where the default-designated region does not exist, the processing of FIG. 38A-38B ends. In a case where it does exist, the processing advances to S3813.

In S3813, the metadata processing unit 112 additionally selects the default-designated three-dimensional region, additionally selects (displays) the three-dimensional region data and the associated annotation information, and ends the processing. Note that regarding the processing relating to the viewpoint position and the view direction, the region data for selection (display) and the annotation information may be switched each time the information of the viewpoint position or the view direction changes, or such switching may not be performed, with data once selected being stored. Note that in a case where three-dimensional image data indicating inside is associated with region data indicating inside and the inside region data and the annotation are selected, reproduction display may be performed by switching the display from the display of the representative image to the three-dimensional image indicating inside or both the representative image and the inside image may be displayed.

According to such a configuration, reproduction processing can be executed of a three-dimensional image file storing metadata corresponding to a three-dimensional image including first region information relating to a first partial region in the three-dimensional image, second region information relating to a second partial region included in the first partial region, first annotation information associated with the first partial region, and second annotation information associated with the second partial region. In particular, by storing the region information as metadata in a pseudo-hierarchical structure, when the region and the annotation information are selected (displayed), the data can be handled by being selectively switched and used. Also, the default selection (display) region data and the annotation not targeted for switching can be made identifiable, allowing the region always selected to be separately identified.

Note that in the present embodiment described above, the annotation information and the region data information are superimposed and displayed together with the representative image. However, display of the annotation information and the region data information may be optional. In other words, this information may be set to be displayed or not on the basis of an instruction such as a UI operation or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-197523, filed Nov. 12, 2024, which is hereby incorporated by reference herein in its entirety.

What is claimed is:

1. An information processing apparatus comprising:
an obtaining unit configured to obtain encoded data of a three-dimensional image and metadata corresponding to the encoded data of the three-dimensional image,
the metadata including:
region information relating to one partial region in the three-dimensional image;
first annotation information and second annotation information that are associated with the one partial region;
first condition information indicating a first condition that is related to display of the first annotation information and that corresponds to a first viewpoint position or a first view direction in a three-dimensional space of the three-dimensional image; and
second condition information indicating a second condition that is related to display of the second annotation information and that corresponds to a second viewpoint position or a second view direction in the three-dimensional space of the three-dimensional image; and
a generating unit configured to generate a three-dimensional image file storing the encoded data of the three-dimensional image and the metadata.

2. The information processing apparatus according to claim 1, wherein
the first condition includes a condition designating a first range of the first viewpoint position in the three-dimensional space.

3. The information processing apparatus according to claim 2, wherein
the first range is a range set based on a user input.

4. The information processing apparatus according to claim 1, wherein
the first condition includes a condition that is based on the one partial region and a projection range of the three-dimensional image onto a display plane set based on the view direction in the three-dimensional space.

5. The information processing apparatus according to claim 4, wherein
the first condition includes a condition that is based on a positional relationship between a straight line, which extends from the first viewpoint position to a reference point of the one partial region, and the projection range.

6. The information processing apparatus according to claim 5, wherein
on a condition that the straight line from the first viewpoint position to the reference point passes through the projection range, the first annotation information is displayed.

7. The information processing apparatus according to claim 2, wherein
the first condition further includes a condition designating a second range of the first viewpoint position in the three-dimensional space.

8. The information processing apparatus according to claim 7, wherein
the second range is a range for which a distance from a reference point of the one partial region to the first viewpoint position in the three-dimensional space satisfies a predetermined condition.

9. The information processing apparatus according to claim 7, wherein
the second range is a range for which a distance between two points corresponding to projections, on an xy plane, of a reference point of the one partial region and the first viewpoint position in the three-dimensional space satisfies a predetermined condition.

10. The information processing apparatus according to claim 1, wherein
the metadata obtained by the obtaining unit further includes priority information indicating which of the first annotation information and the second annotation information is to be displayed in a case where the first condition and the second condition are satisfied.

11. The information processing apparatus according to claim 1, wherein
the metadata obtained by the obtaining unit further includes information indicating default annotation information to be displayed in the three-dimensional image in a case where the first condition and the second condition are not satisfied.

12. The information processing apparatus according to claim 1, wherein
the metadata obtained by the obtaining unit further includes information indicating a reference point of the one partial region.

13. The information processing apparatus according to claim 1, wherein
the metadata includes first region information relating to a first partial region as the one partial region, second region information relating to a second partial region included in the first partial region, the first annotation information associated with the first partial region, and the second annotation information associated with the second partial region.

14. The information processing apparatus according to claim 13, wherein
the metadata further includes condition information that indicates the first condition and the second condition and that corresponds to a viewpoint position or a view direction in the three-dimensional space of the three-dimensional image at a time of reproducing the three-dimensional image file.

15. The information processing apparatus according to claim 14, wherein
the condition information includes a condition that, in a case where the viewpoint position is included in the first partial region and not included in the second partial region at a time of reproducing the three-dimensional image file, the second annotation information is displayed if the second condition is satisfied, and the second annotation information is not displayed if the second condition is not satisfied.

16. The information processing apparatus according to claim 14, wherein
the condition information includes a condition that the first annotation information is displayed in a case where a straight line from the viewpoint position to a reference point of the first partial region passes through a projection range of the three-dimensional image onto a display plane set based on the view direction in the three-dimensional space, and that the second annotation information is displayed in a case where a straight line from the viewpoint position to a reference point of the second partial region passes through the projection range.

17. The information processing apparatus according to claim 13, wherein
one or both of the first annotation information and the second annotation information is annotation information always displayed at a time of reproducing the three-dimensional image file.

18. The information processing apparatus according to claim 13, wherein
the metadata further includes a third partial region that is different from the second partial region and is associated with the first partial region, and third annotation information associated with the third partial region.

19. An information processing apparatus comprising:
an obtaining unit configured to obtain a three-dimensional image file storing encoded data of a three-dimensional image and metadata corresponding to the encoded data of the three-dimensional image,
the metadata including;
region information relating to one partial region in the three-dimensional image;
first annotation information and second annotation information that are associated with the one partial region;
first condition information indicating a first condition that is related to display of the first annotation information and that corresponds to a first viewpoint position or a first view direction in a three-dimensional space of the three-dimensional image; and
second condition information indicating a second condition that is related to display of the second annotation information and that corresponds to a second viewpoint position or a second view direction in the three-dimensional space of the three-dimensional image; and
a reproducing unit configured to reproduce the three-dimensional image file.

20. An information processing method comprising:
obtaining encoded data of a three-dimensional image and metadata corresponding to the encoded data of the three-dimensional image,
the metadata including:
region information relating to one partial region in the three-dimensional image;
first annotation information and second annotation information that are associated with the one partial region;
first condition information indicating a first condition that is related to display of the first annotation information and that corresponds to a first viewpoint position or a first view direction in a three-dimensional space of the three-dimensional image; and
second condition information indicating a second condition that is related to display of the second annotation information and that corresponds to a second viewpoint position or a second view direction in the three-dimensional space of the three-dimensional image; and
generating a three-dimensional image file storing the encoded data of the three-dimensional image and the metadata.

21. An information processing method comprising:
obtaining a three-dimensional image file storing encoded data of a three-dimensional image and metadata corresponding to the encoded data of the three-dimensional image,
the metadata including;
region information relating to one partial region in the three-dimensional image;
first annotation information and second annotation information that are associated with the one partial region;
first condition information indicating a first condition that is related to display of the first annotation information and that corresponds to a first viewpoint position or a first view direction in a three-dimensional space of the three-dimensional image; and
second condition information indicating a second condition that is related to display of the second annotation information and that corresponds to a second viewpoint position or a second view direction in the three-dimensional space of the three-dimensional image; and
reproducing the three-dimensional image file.

22. A non-transitory computer-readable storage medium storing a computer program comprising instructions which, when the program executed by a computer, cause the computer to carry out the information processing method of claim 20.

23. A non-transitory computer-readable storage medium storing a computer program comprising instructions which, when the program executed by a computer, cause the computer to carry out the information processing method of claim 21.
